(19) United States
(12) Patent Application Publication
(10) Pub. No.: US 2026/0170705 A1
(43) Pub. Date: Jun. 18, 2026

(54) ARTIFICIAL INTELLIGENCE-BASED TEXT-TO-VIDEO MESSAGING SYSTEM, APPLICATION AND METHOD

(71) Applicant: Larry M Shultz, Beverly Hills, CA (US)

(72) Inventor: Larry M Shultz, Beverly Hills, CA (US)

(21) Appl. No.: 18/985,495

(22) Filed: Dec. 18, 2024

(51) Int. Cl. G06T 11/00; G06F 9/451; G06F 16/483; G06Q 50/00; G10L 13/08

(52) U.S. Cl. CPC G06T 11/00; G06F 9/451; G06F 16/483; G06Q 10/40; G10L 13/08; G06T 2211/441

(57) ABSTRACT

The present disclosure relates to a computer-implemented platform for generating personalized text-to-video messages for social media. The platform features a user interface for inputting text and selecting multimedia content types. A pre-trained large language model (LLM) processes these inputs, leveraging a Knowledge Base containing data from sources like news, government statistics, polls, and academic publications. The LLM generates draft messages based on user-selected topics or pre-existing content, such as news articles or press releases, with options for user modifications. The system also includes an AI-powered text-to-audio generator that converts text into narrated audio, an image search engine for identifying relevant multimedia content, and an AI-based video generator that synchronizes audio with images, video segments, and text-based graphics. The final output is a shareable video or audio file, suitable for distribution via email, SMS, or social media platforms.

### FIELD OF THE INVENTION

The present invention relates to methods for leveraging social media platforms to increase distribution and viewership of automated and fact-checked text-to-video messages that can educate and inform social media users/message-recipients about things of interest or relevance to them, personally and locally. More specifically, the present invention automates the production of Text-to-Narrated Audio-to-Video with Relevant Quotes Displayed in sync with the Narration and relevant Graphics (including statistical, financial, or informational pictures, slides, maps, tables, charts, or graphs) to increase viewer comprehension and retention. This invention, among other things, uses the personal connection between local Smartphone owners and the local businesses in their areas to increase consumer product interest and sales at local retailers, enhance public education and awareness, and instill new pride and confidence in government disclosures and actions of local and national public interest.

### BACKGROUND

In the digital age, the consumption habits of American citizens have undergone a significant transformation. Traditional forms of media such as newspapers, magazines, and even online publications are being side lined in favor of video content. The preference for video content is not just a trend; it is a fundamental change in how information is consumed. Videos are more engaging, accessible, and easier to understand than written text. They cater to the fast-paced lifestyle of modern citizens who often prefer to watch a brief video rather than read an article.

Social media platforms with text-based and video-based formats have become integral to modern communication. This massively growing audience of social media users/viewers prefers to watch videos instead of reading printed newspapers or magazines. Increasingly, the growing new generation of citizen-consumers gets their news and information from online video platforms inundated with misinformation and disinformation. This shift from traditional news sources has led to a concerning issue: the inability of many users to discern between real news online and misinformation. Studies have shown that purposeful lies, propaganda, misinformation, and disinformation are rampant on these platforms, influencing public opinion and swaying real-life decisions based on incorrect or incomplete information.

This shift in media consumption necessitates a corresponding change in how corporations and the government communicate with the public, and this shift presents a unique challenge for the government, which relies heavily on written communication to disseminate important information. Therefore, there is a public need to replace social media misinformation and disinformation with fact-checked news and information from reliable journalistic newspapers and media resources on social media to more effectively reach, engage, appeal to, and inform younger social media users of the real news and current events happening locally, nationally and globally. This would help combat the spread of misinformation and ensure that the new generation of viewers, who prefer watching videos over reading, are well-informed and not misled by false information.

At the same time, the traditional newspaper and magazine industries are also in crisis in the digital age. Declining readership and profitability coincide with the rise of internet and social media platforms that have fundamentally changed how important news, articles, or editorial concerning political as well as social issues, are consumed. Younger generations-Gen Y, Gen Z, and Gen Alpha—are increasingly relying on digital video platforms like TikTok, YouTube, and Instagram for their political/social information, leading to a significant drop in print subscriptions and advertising revenues. According to research published in the Journal of Experimental Psychology: Learning, Memory, and Cognition, visual information is mapped better in the brain, leading to improved recall by transitioning information from working memory to long-lasting memory, making it easier to remember the content.

Unfortunately, online platforms often lack the journalistic integrity of traditional outlets and are inundated with misinformation and disinformation, which undermines the credibility of political discourse. This environment fosters a dangerous landscape where political opinions are shaped by sensationalism rather than facts, leaving younger audiences uninformed or misinformed about crucial political issues and candidates. As a result, this contributes to apathy and disengagement from the democratic process, presenting a significant challenge for traditional media to reclaim their role as trusted sources of political news while combating the spread of false information that threatens informed citizenry.

The declining consumption of traditional news content among younger audiences also coincides with a disturbing trend in American education: a decline in reading comprehension scores. Data from the National Assessment of Educational Progress (NAEP) shows that reading scores among 9-year-olds dropped by five points from 2020 to 2022, marking the largest decline in decades.

Meanwhile, the rapid development of artificial intelligence (AI) and machine learning technologies has created significant opportunities for innovation across various sectors, including media, entertainment, and education. The global conversational AI market, for example, was valued at over $7.6 billion in 2022 and is projected to grow at an impressive compound annual growth rate (CAGR) of 23.6% through 2030. As AI continues to become more advanced, media organizations have started exploring its use for content creation, distribution, and audience engagement, offering new ways to address declining readership while improving operational efficiencies.

There is therefore a pressing need for an AI-managed Video Clip Library Descriptor Code that leverages the power of advanced semantic-matching and language models to analyze and break down video content with unprecedented precision and then assign an pre-determined Intensity Value for one or more Video Clip Descriptor categories by which every video clip scraped or scanned or played is labeled for future identification and use. This allows for the creation of meticulously curated descriptors that can capture every aspect of a video scene, from the type of action taking place to the specific lighting conditions and background elements, ensuring unparalleled accuracy in identifying and categorizing video clips. By implementing a robust system with these comprehensive descriptors, video clip libraries can significantly enhance their usability and relevance. Users will be able to find clips with fast searches that match their specific needs with greater accuracy, reducing time spent on searches and increasing overall satisfaction. This system also facilitates the creation of more cohesive and meaningful content, as users can seamlessly integrate clips that align perfectly with their narratives.

There is further a clear and pressing need to bridge the gap between traditional news organizations and the digital consumption habits of younger generations by engaging young generations in a format that they prefer while simultaneously improving their reading comprehension and knowledge retention.

There is also a pressing need to leverage AI for an AI-driven Fact-Check and Truth-Reliability assessment to check the integrity of the AI-generated content for circulation by the users. There is a further need to leverage AI and blacklist such websites that are known for spreading fake news based on third parties observation and use the generated list of blacklisted websites to generate videos that refute misinformation with verified facts.

There is also a clear and pressing need to overcome the problem of declining reading scores of the younger generation by increasing comprehension of educational and informational video content through the display of key-word phrases and quotations from the narration as text-graphics to capture and maintain viewer's attention-leveraging the dual-coding theory, which posits that information is more easily learned and retained when combining visual images and auditory narration that engages different parts of the brain, reinforcing information comprehension and improving long-term retention.

There is further a pressing need to incorporate statistical, financial, and informational drawings pictures, slides, maps, charts, tables, and graphs as images in informational and educational text-to-videos because they cater to the visual learning style of many individuals, making complex information more accessible and memorable, thereby leading to improved recall by transitioning information from working memory to long-lasting memory, making it easier to remember the content.

### OBJECTIVE OF THE INVENTION

The present invention aims to address the aforementioned issues of low readership, high video viewership, and the need for corporations, educational institutions, social causes/charitable foundations, and the government to convert their written information into narrated videos.

An objective of the present invention is to create a novel system/method/apparatus that enables the use of AI/machine learning to use the visual contents of the Knowledge Base that contains statistical graphs, charts, and tables as the Visual Images to be used in a combination of Text-to-Audio matched with Text-to-Image processes that match the visual meaning/interpretation of the Text-based words/phrase and meaning of the narrated text for government, corporate and social cause/charitable foundation to use to reach their target audiences and constituencies.

An objective of the present invention is to automate the process of compiling and displaying relevant visual images from online resources; graphs, charts, and tables from the Knowledge Base resources used in the creation of the text-based message; and available video-segments from online resources, finalized with user-input/written Title Graphics, End Credits/Contact/Donation Links, and pan/zoom/wipe image-transitions to create visually-appealing and intellectually-interesting Issue-oriented short-form Documentary-style Video of images that are relevant to the words/phrases/meaning and issue/theme/tone of the text-based message, and timed exactly to accompany the text-to-voice audio narration.

Another objective of the present invention is to create social cause-promoting messages in multiple message formats to reach the maximum number of users first as a Text-based Message that can be shared by email, by SMS/text-messaging and on X/Threads and Facebook social media messaging platforms; as a Narrated Text-to-Audio file format for Podcasts and Radio promotional segments; and as a Documentary-style Narrated Video file format for the most popular online/mobile platforms, TikTok, Instagram, Snapchat and YouTube, serving audiences with hundreds of millions of viewers daily, who may not be frequent users of X/Threads or other text-based social media.

Another objective of the present invention is to meet the increasing demand for digital video as a primary source of educational and social information, particularly among younger audiences while ensuring the content is accurate and credible. By utilizing AI to generate personalized political/social/consumer videos, the system effectively bridges the divide between traditional political and consumer brand-promoting communications and modern digital consumption trends. It provides an innovative solution for delivering fact-based, engaging, and customized political and consumer messages in the video formats favored by today's users, promoting a more informed and actively engaged electorate.

Additionally, the present invention aims to automate not only the creation of documentary-style short-form videos to educate and inform audiences who no longer get their news from traditional published news media but from online video platforms, to also reinforce information comprehension and improve longer-term retention of the content of the videos by combining the auditory narration with the quoted words displayed on screen in sync with the narration, which engages different parts of the brain, reinforcing the memory and impact of the video message.

Another objective is to use AI and machine learning technologies to search statistical databases, like the U.S. Census, Federal Reserve, Pew Research opinion polls, for relevant statistical charts, tables and graphs to be used as images in text-to-videos created by the present invention to further reinforce information comprehension and improve longer-term retention of the content of the videos by combining the auditory narration with visual statistical charts, tables and graphs that are relevant to the subject matter or semantic meaning of the narrated content.

Another objective of the present invention is to use AI and machine learning technologies for more granular curation of the world's growing number of online videos by using AI to scan online video content, break each video into 3-5 second long video-clips, then characterize, describe and name such video-clips and related access information in our Knowledge Base for “fair use” in subsequent educational, news and public disclosure videos.

Yet another objective is to leverage advanced language models to analyze and break down video content with unprecedented precision for the creation of detailed descriptors that can capture every aspect of a scene, from the type of action taking place to the specific lighting conditions and background elements in order to more accurately match images and video clips with the semantic meaning of the narrated words.

It is a further objective of the present invention to convert written information issued or disclosed by the government, which a growing majority of citizens won't read, into short-form videos they will watch, in order to educate and inform them about their rights as citizens and about the current activities of what the various government agencies are doing or announcing that affect the citizenry. By converting the written disclosures of public agencies into narrated videos, important information would become more accessible to local citizens, but also ensure that it reaches a wider audience because videos can simplify complex information, making it easier for citizens to understand and engage with the content. By embracing this change, the government can enhance transparency, accountability, and public trust.

Another objective of the present invention is to provide a Fact-Check and Truth-Reliability evaluation of all information used by the Knowledge Base to prevent dissemination of fake-news, misinformation, and disinformation by creating a Whitelist of reliable websites with reputations for truthful information and a Blacklist of websites known for spreading lies and misinformation, particularly those created by foreign governments for nefarious purposes, and cross-referencing all sources of information used by the Knowledge Base against this blacklist and whitelist to ensure that only reliable, fact-checked information is presented to viewers, which is essential for a healthy democracy.

A further objective of the present invention is to provide a platform that enables users to monetize their video content by seamlessly integrating advertising opportunities such as but not limited to graphic banners, QR codes, and clickable buttons, facilitating sponsorships, partnerships, and other revenue-generating strategies.

### SUMMARY OF THE INVENTION

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only, and is not intended to limit the scope of the present disclosure.

In accordance with an aspect of the present invention, a computer-implemented system for generating text-to-video messages for social media is disclosed. The system interfaced with a Knowledge Base, comprising a user interface receiving one or more inputs, like a source of user-selected written content input in text format, document file format, website address or webpage address of content to be semantically-summarized by AI and converted into a narrated video; or input of text and web content addresses and search-results into the Knowledge Base of text, images, video segments, graphics, modifiers and search results for subsequent text-to-video conversions; or user-selected average screen-time (number of seconds) per video image; or user-selected quotation-frequency of visual-text quotes to be displayed in the video per-minute or visual quotes to be displayed over every image or over every pre-determined number of images throughout the video.

In an embodiment. said system comprises at least one pre-trained large language model (LLM) configured to receive one or more inputs, the large-language model configured with in-context learning using examples from data in the Knowledge Base having data categories including subject-based data, people-based data, geospatial-location data, financial/transactional data, sensor data, non-numeric qualitative data, numeric quantitative data, administrative data, and behavioral data, in text format, in image/video clip format and statistical chart/table/graph format from governmental, educational, corporate, non-profit organization and private online resources, from one or more multimedia websites.

In another embodiment, said system includes a pre-trained embedding model for embedding generation, wherein the pre-trained embedding model is configured to select semantically similar parts of the written content obtained from input and provide contextual information related to the written content to at least one pre-trained LLM, wherein the LLM is further configured to create a draft text content based on user-chosen message topics/issues, already-written or published content and content modifiers to personalize the draft text with subsequent draft content modifiers as needed by a user to create a personalized summarized draft text content approved to the personal satisfaction of the user.

In yet another embodiment, the system includes an AI text-to-audio Generator combining information from the large language model, using unsupervised and supervised learning techniques, to create an AI-narrated audio file from the verbatim or summarized text content with a user approved narration voice and narration type.

In an embodiment, the system also includes an image search engine for searching one or more multimedia databases for at least one of an image, a graphic, or a video segment that visually and semantically relevant to, and in sync with, the contextual information and semantic-meaning of the written content.

In a further embodiment, said system includes an AI-based text-to-graphics generator combining information from the large language model, using unsupervised and supervised learning techniques, to list the most semantically-relevant word phrases or sentences for the user to choose, or for AI to automatically choose, to display as a colored, static-or-moving text-graphic in sync to and simultaneously with the spoken narrated audio words.

In another embodiment, said system includes an AI-based video generator for synchronizing the generated AI-narrated audio file with at least one of an image, a graphic, or a video segment obtained by the image search engine that are semantically matching to the contextual information to create and distribute an AI-generated video file by the user via email, and/or various social media platforms.

In an embodiment, the source of written content is selected from contents related to social, charitable, educational, and political causes, donation-soliciting messages, consumer product promoting advertisements, press releases, published academic, medical, and research-related papers, articles, books, and journals, local and global news content, local/state/federal government agency statistics and disclosures, corporate financial disclosures and regulatory filings, public census results, voter and consumer opinion polls, social media messages and online news user comments, parliamentary/legislative updates and bulletins about new or pending local and federal laws and legislation, and the written content, graphics, images and/or videos on websites and webpages.

In one embodiment, the content modifiers are selected by the user for (i) adding online information links to the message knowledge base, or (ii) selecting a theme/tone of the narrated video, (iii) selecting a preferred duration of video length, (iv) selecting a graphical-text quotation-frequency, (v) selecting an average image/video segment screentime, (vi) composing an Opening Title sequence text-content, (vii) composing an End Title sequence text-content, (vii) composing or selecting a final background music and (vii) composing or selecting a final narration voice and narration type.

In another embodiment, the AI text-to-audio generator determines the length of the generated AI-narrated audio file and divides the audio file length in time, using an image screen-time modifier, by a predefined time interval to determine the number of images, graphics or video sequences required for the creation of the AI-generated text-to-video file of a pre-determined length of time.

In one embodiment, the AI text-graphics generator determines the length of the generated AI-narrated audio file and divides the audio file length in time by a user-chosen quotation-frequency factor selected from (a) the number of graphical text quotes to display per minute, or (b) display one text quote on every image or (c) on every pre-determined number of images in the video, to determine the timing and number of word-phrases/quotes needed to be overlayed and displayed in sync to the narrated video.

In a further embodiment, the image search engine uses LLM model with in-context learning to generate search keywords searching one or more multimedia databases for at least one of an image, a graphic, or a video segment that is visually and semantically relevant to the contextual information and meaning of the written content.

In yet another embodiment, the LLM model includes an automated multimedia retrieval engine for parsing one or more multimedia websites, using Large Language Models (LLMs), and retrieving images, graphics and videos segment, wherein the multimedia retrieval engine scrapes various social media platforms and direct news links for effective image processing.

In a further embodiment, the AI-based video generator automatically selects images, video segments, and graphical elements, that conveys a narrative aligned with the emotional and visual theme/tone selected by the user and relevant to the contextual information of the created AI message.

In an embodiment, the knowledge base is continually updated with images, graphics, and video segments retrieved by the LLM model from continually searching various multimedia databases along with their contextual meaning to build a knowledge base of visual content with searchable key-word descriptions, allowing the creation of semantically-accurate text-to-image/videos for distribution.

In an alternate embodiment, the knowledge base is continually updated with images, graphics, and video segments searched or retrieved by the LLM model that are identified, described, categorized and labeled with one or more attribute descriptors out of a plurality of unique descriptors, including but not limited to, an action description, location setting, main subjects of the scene, mood/atmosphere, an event type. duration of the clip, time of day, camera angle/shot type, sound/music characteristics, color tone, lighting conditions, genre, language, special effects/visual enhancements, costumes/attire: descriptions, character interaction, directional movement pacing, weather conditions, historical context, theme, props, background elements, sound effects, speech patterns, cinematography style, narration presence, scene transition, editing style, symbolism, cultural references, and other differentiating image characteristics to improve accuracy of future image searches for video clips and images to be used in videos

In an embodiment, the LLM uses facial recognition to generate and tag name of the fictional characters or name of the people appearing in images featured in the video clips of pre-set time length stored in the knowledge base.

In a further embodiment, the LLM model assigns a pre-determined value for each of the identified attribute descriptors to build the knowledge base to increase semantic-text to semantic-image/video segment matching accuracy.

In an embodiment, the system further comprises an AI-based dynamic ad generator for dynamically selecting sponsor-related advertisements that match the contextual information of the written content and incorporating the advertisements in the AI-generated video.

In another embodiment, the AI-based dynamic ad generator creates placeholders within the AI-generated video during synchronization for incorporating sponsor-related advertisements.

In yet another embodiment, the AI-based dynamic ad generator creates the placeholders at a pre-determined time interval within the AI-generated video, preferably at the beginning, the middle, and at the end of the AI-generated video.

In an alternate embodiment, the system is configured to proportionately reward the activities of registered users for the amount of time they spend watching text-to-videos produced by the present invention in the form of rewards points earned for every minute of video played, or every partial or complete video viewed, which rewards points are redeemable by QR Code and weblinks for local retail store discounts, coupons and rebates at local supermarkets, restaurants, gasoline stations, and local businesses that believe they have a local corporate responsibility to support their local communities and consumers by sponsoring educational text-to-videos whose subject matter may relate to their own businesses for which they seek to educate and inform their growing customer base of non-readers who predominantly prefer video as their communications medium of choice.

In another aspect of the present invention, a computer-implemented method for generating text-to video messages using an AI-based system interfaced with a Knowledge Base over a network is disclosed. The method comprising the steps of receiving one or more user inputs, like a source of user-selected written content input in text format, document file format, website address or webpage address of content for semantically-summarizing by AI and converted into a narrated video; or input of text and web content addresses and search-results into the Knowledge Base of text, images, video segments, graphics, modifiers and search results for subsequent text-to-video conversions; or user-selected average screen-time (number of seconds) per video image; or user-selected quotation-frequency of visual-text quotes to be displayed in the video per minute or visual quotes to be displayed over every image or every pre-set number of images throughout the video.

In an aspect, the method utilizes a large language Model with in-context learning using examples from data in the Knowledge Base to process contextual information from the received one or more inputs for creating a draft text content message topics/issues, already-written or published content and content modifiers, considering user-chosen average screen-time (number of seconds) per video image; or user-selected quotation-frequency of visual-text quotes to be displayed in the video per minute or visual quotes to be displayed over every image or every pre-set number of images throughout the video.

In a further aspect, the method searches in the Knowledge Base using the contextual information with data categories, like subject-based data, people-based data, geospatial-location data, financial/transactional data, sensor data, non-numeric qualitative data, numeric quantitative data, administrative data, and behavioral data, in text format, in image/video clip format and statistical chart/table/graph format from governmental, educational, corporate, non-profit organization and private online statistical, opinion-polling and other resources from one or more multimedia websites;

In one aspect, the method converts, using an AI-based text to audio generator, the generated summarized draft text content into an AI-narrated audio file from the verbatim or summarized text content with a user-approved narration voice and narration type.

In another aspect, the method searches, using an image search engine using an LLM model, one or more multimedia databases for at least one of an image, a graphic, or a video segment that is visually and semantically relevant to, and in sync with the contextual information of the summarized draft text content.

In yet another aspect, the method combines, using an AI-based text to graphic generator, information from the large language model, to list one or more semantically-relevant word phrases or sentences per minute of narration for user to choose, or for AI to automatically choose, to display as a colored, static-or-moving text-graphic in sync to and simultaneously with the spoken narrated audio words.

In a further aspect, the method synchronizes, using an AI-based video generator, the generated AI-narrated audio file with at least one of an image, a graphic, or a video segment that is semantically matches the contextual information to create and distribute an AI-generated video file by the user via email, SMS/text and/or social media messaging platforms.

In an aspect, the content modifiers are selected from a narrated length of the message, and additional message subject, visual graphics or images to be included from the Knowledge Base, average screen time per image/video segment, and read-along text graphic for every pre-determined number of images.

In another aspect, the method for synchronizing includes determining the length of the generated AI-narrated audio file and dividing the audio file by a predefined time interval, using an image screen-time modifier, to determine the number of images, graphics, or video sequences required for the creation of the AI-generated text-to-video file of a pre-determined length.

In yet another aspect, the method for combining further includes determining the narration length of the generated AI-narrated audio file and dividing the audio file length in time by a user-chosen “quote frequency factor” selected from the number of graphical text quotes to display per minute, display one text quote on every image, or display on every pre-determined number of images in the video, to determine the timing and number of word-phrases/quotes needed to be overlayed in sync to the narrated video.

In another aspect, the method for searching further includes using the LLM model with in-context learning to generate search keywords for searching one or more multimedia databases for at least one of an image, a graphic, or a video segment that is visually and semantically relevant to the contextual information and meaning of the written content.

In an alternate aspect, the method further comprises creating placeholders, using an AI-based dynamic ad generator, within the AI-generated video during synchronization for incorporating sponsor-related advertisements and dynamically selecting sponsor-related advertisements that match the contextual information and meaning of the draft text content.

In yet another aspect of the invention, a computer-implemented method for analyzing integrity of an information using an AI-based system interfaced with a Knowledge Base over a network is disclosed. Said method comprises receiving one or more user inputs, such as a text input, a website address, a webpage address, web content addresses, or search-results of text, images, video segments, or graphics and utilizing a large language Model with in-context learning using examples from data in the Knowledge Base to process contextual information from the received one or more inputs into creating a summarized draft text content.

In an aspect, the method comprises comparing the summarized text content, using an AI evaluator that includes an LLM model, against a pre-determined list of truth descriptors and assigning an integrity score for the summarized draft text based on the comparison results and providing feedback on the integrity of the summarized draft text to the user based on the generated integrity score, wherein the integrity score and the feedback indicates the degree of accuracy and reliability of the summarized draft text.

In a further aspect, the method includes converting, using an AI-based text-to-audio generator, the generated summarized draft text content into an AI-narrated audio file from the summarized text content taking into account the feedback on the integrity of the summarized draft text and the generated integrity score with a user approved narration voice and narration type;

In another aspect, the method further includes searching, using an image search engine that includes an LLM model, one or more multimedia databases for at least one of an image, a graphic, or a video segment that visually- and semantically-matches, is relevant to and in sync with the contextual information and meaning of the summarized draft text content; and combining, using an AI-based text-to-graphic generator, information from the large language model, to list a pre-determined number of most semantically-relevant word phrases or sentences per minute for user to choose, or for AI to automatically choose, to display as a colored, static-or-moving text-graphic in sync to and simultaneously with the spoken narrated audio words.

In yet another aspect, the method comprises synchronizing the generated AI-narrated audio file, using an AI-based video generator, with the at least one of an image, a graphic, or a video segment that is semantically matched to the contextual information to create and distribute an AI-generated video file by the user via email, SMS/text and/or social media messaging platforms.

In another aspect, the pre-determined list of truth descriptors that identifies information and categorises said information into one or more categories selected from fake for entirely fabricated information, false for information contradicting verified records, misleading for twisted based on fact, unproven for lack of evidence to support/disregard the information, inaccurate for inaccuracies in data; context-required for lacking supporting contextual information; flip-flop for change in stance of public figure; unsubstantiated for being based on rumors; partially true for having mix of truth and friction; overgeneralization for broad information lacking specific evidence, speculative for being based on conjecture, and anachronistic for being based on evidence on a wrong time period.

In yet another aspect, the step of comparing using an AI evaluator includes scanning websites and summarizing information from said websites to identify key rumors, conspiracy stories and lies by evaluating against one or more reliable sources, including governmental, academical, and verified media outlets, to create a list of blacklisted websites for storing and storing the Knowledge base with corresponding truth descriptors.

In a further aspect, the step of generating AI summarized text includes information from the Knowledge Base that has been updated with pre-screened and graded using the pre-determined list of Truth Descriptor for reliability, accuracy, and source reputation of the information, wherein the information with a low integrity score is excluded from the Knowledge Base.

In yet another aspect, the step of comparing further includes dynamically monitoring and updating the Blacklisted websites and Truth Descriptor Intensity scores for preventing any information from the Blacklisted websites for inclusion in the Knowledge Base, to ensure the Knowledge Base remains free of false or unreliable data and maintain credibility of AI-generated summaries and outputs.

Various objects, features, aspects, and advantages of the inventive subject matter will become more apparent from the following detailed description of preferred embodiments, along with the accompanying drawing figures in which the same numerals represent like components.

### BRIEF DESCRIPTION OF THE DRAWINGS

Non-limiting examples of the present disclosure will be described in the following disclosure with reference to the appended drawings, in which:

FIG. 1 illustrates an exemplary network diagram for implementing a computer-based system for AI-enhanced message creation and distribution system, according to an embodiment of the present invention;

FIGS. 2A-2B illustrates a flow diagram for parsing and retrieving data from websites, according to an embodiment of the present invention.

FIGS. 3A-3D illustrates a flow diagram for different modules of the web application of the system displayed on the user device, according to an embodiment of the present invention.

FIG. 4 illustrates a Flow Diagram depicting a workflow of generating a personalized text-to-video, according to an embodiment of the present invention.

FIG. 5 illustrates a Flow Diagram depicting a workflow of detecting the integrity of information using a pre-determined list of truth descriptors, according to an embodiment of the present invention.

### DETAILED DESCRIPTION OF THE DRAWINGS

Some embodiments of this invention, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present invention, the preferred, systems and methods are now described.

The younger generation of social media users no longer get their news and information from TV nor printed or online newspaper and magazine sources of journalistic integrity. This has created a pressing social need for a more effective and innovative approach to motivating the majority of citizens to participate in the electoral process. More particularly, it is required to have a system and a method for leveraging social media platforms to increase distribution and viewership of automated and fact-checked text-to-video messages that can educate and inform social media users/message-recipients about things of interest or relevance to them, personally and locally.

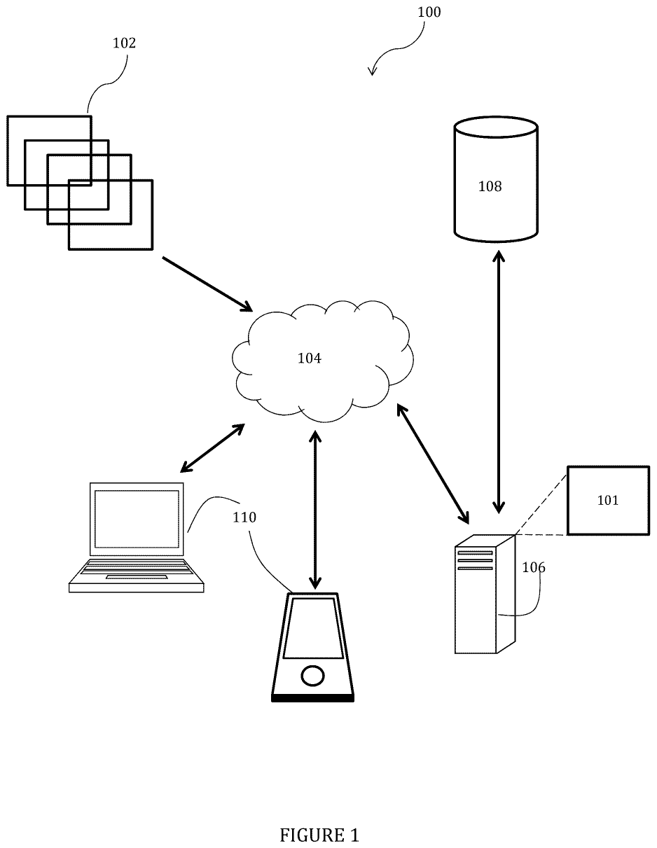

FIG. 1 illustrates a network diagram 100 for implementing an AI-based system 101 (hereinafter, the system 101) for an AI-assisted text-to-video message creation. As shown, multiple user devices 110-1, 110-2, . . . , 110n (collectively referred to as 110) may be available to communicate with a server 106 over a network 104, wherein the server 106 may host the system 101. The system 101 may have its own dedicated storage and processing capabilities. In another embodiment, the user device 110 may be executing a digital assistant application (not shown), which can be a computer-based software application or a web application. The digital assistant application can communicate with, or form a portion of, the system 104. For example, the user devices 110 may be used by any citizen in general who would like to receive data from, or send data to, the server 106 on certain issues to create a video message. This distribution of server 106 amongst the various stakeholders may be provided, for example, by way of a distributed computing network having several devices under the control of the ecosystem members, and running all or a portion of the system 101 while interconnected by the network 104. The stakeholder inputs may encompass public content and comments, such as content related to social, charitable, educational, and political causes donation-soliciting messages, consumer product promoting advertisements, press releases, published academic, medical, and research-related papers, articles, books, and journals, local and global news content, local/state/federal government agency statistics and disclosures, corporate financial disclosures and regulatory filings, public census results, voter and consumer opinion polls, social media messages and online news user comments, parliamentary/legislative updates and bulletins about new or pending local and federal laws and legislation, and the written content, graphics, images and/or videos on websites and webpages.

In an embodiment, server 106 may be a remote server or a cloud server and is configured to access a plurality of databases 108 to fetch industry-specific updates and information in real-time. The communication network 104 pertains to either a wired or wireless system utilized for data transmission. The network 104 facilitates seamless communication and data exchange between the user 110 and the server 106. The server 106 is adapted to store training dataset 108 which helps the system 101 to learn automatically using machine learning.

In an embodiment, system 101 is configured to handle and analyze user queries received as inputs and ensures efficient interaction and information flow. System 101 is hosted on server 106 which multiple users can access through the web application on their user devices 110. To leverage the functionalities provided by the system, users are required to register with the web application from their respective user devices 110, providing necessary details, including personal information and contact details. Upon registration, users undergo authentication processes to verify their identity. Authorized users gain access to the full functionality of the system.

In an embodiment, the users access the system 101 by registering to the system from their respective user devices 110 through the web application which may include various modules AI Message Generator Module, and Location-Based Message Distribution Module offering holistic insights, efficient messaging, an AI text-to-audio Generator, an AI-based text-to-graphics generator, an AI-based video generator, and a user-focused experience for unparalleled engagement with political landscapes.

In an embodiment, the multiple users registered to the system 101 hosted on the server 106 may access the system 101 through the secured network connection 104, the users can register to the system 101 through the web application from their respective devices 110. System 101 access the user's location from the user's devices 110 and accesses the location of the user through any of the methods by establishing a connection between the user's MAC Address, web IP, or GPS Smart Phone position to determine the User's location at the discretion of the user.

In another embodiment, the system 101 receives, from a user interface, one or more inputs, like a source of user-selected written content input in text format, document file format, website address, or webpage address of content to be semantically-summarized by AI and converted into a narrated video. Alternatively, one or more users may use the user interface to input text and web content addresses and search-results into the Knowledge Base of text, images, video segments, graphics, modifiers, and search results for subsequent text-to-video conversions. System 101 may also receive user-selected average screen-time (number of seconds) per video image, or user-selected quotation-frequency of visual-text quotes to be displayed in the video per minute or visual quotes to be displayed over every image or every pre-set number of images, for example for every 2-5 images, throughout the video.

In an embodiment, system 101 generates an extensive Database, systematically capturing and analyzing the opinions of individual users on a myriad of social problems and contemporary issues. By harnessing advanced AI algorithms, system 101 creates a nuanced understanding of each users perspectives, forming a comprehensive database 108 that serves as the foundation for personalized messaging strategies for the users registered to system 101 through their respective user devices 110. There may be a plurality of databases generated including a database that encompasses user details and donation information, a Profile Database as a reservoir of specific quotes, comments, positions, and stances adopted by notable personalities that not only assists in messaging strategies but also serves as a secure and authenticated platform for personalized engagement. In another embodiment, system 101 generates a database related to subject-based data, people-based data, geospatial-location data, financial/transactional data, sensor data, non-numeric qualitative data, numeric quantitative data, administrative data, and behavioral data, in various formats such as text format, image/video clip format, and statistical chart/table/graph format.

In alternate embodiments, the AI-based system 101 uses large language as well as semantic search-based algorithms to search known databases such as, but not limited to, major online news media, blogging databases having reader comments, social media databases having discussions, opinions, posts, legislative voting records, one or more governmental, educational, corporate, non-profit organization, private online resources, one or more multimedia websites, and other official sources to generate a Knowledge Database 108. The purpose of Knowledge Database 108 is to comprehensively store data about districts, images, video segments, and graphical elements with searchable key-word descriptions identified, described, categorized, and labeled with one or more number of attribute descriptors out of a plurality of unique descriptors, for example at least five attribute descriptors, in a structured manner for displaying to users and generating a political message by the system 101.

In an embodiment, the attribute descriptors are selected from, but not limited to, an action description, location setting, main subjects of the scene, mood/atmosphere, an event type, duration of the clip, time of the Day, camera Angle/Shot Type, sound/music characteristics, color tone, lighting conditions, genre, language, special effects/visual enhancements, costumes/attire: descriptions, character interaction, directional movement, pacing, weather conditions, historical context, theme, props, background elements, sound effects, speech patterns, cinematography style, narration presence, scene transition, editing style, symbolism, cultural references, and other differentiating image characteristics to improve accuracy of future image searches for video clips and images to be used in videos.

System 101 includes a tool that supports custom information search and extraction from a set of specified websites, enhancing the breadth of data collection. Various data extraction libraries such as Selenium, Beautiful Soup, request packages in Python, and the like are employed to automate the parsing and retrieval of data from select websites, thus ensuring accuracy and effectiveness in data extraction.

In an embodiment, the system incorporates an In-Context Learning technique which facilitates the LLM to perform task-specific information extraction based on the provided examples and instructions. For in-context learning, the LLM may use examples from data stored in the Knowledge Base having data categories including subject-based data, people-based data, geospatial-location data, financial/transactional data, sensor data, non-numeric qualitative data, numeric quantitative data, administrative data, and behavioral data, in text format, in image/video clip format and statistical chart/table/graph format from a governmental, educational, corporate, non-profit organization and private online resources, from one or more multimedia websites. This process enables the model to understand the intricacies of political discourse, discern contextual nuances, and accurately extract information essential for subsequent tasks.

In a further embodiment, the LLM is configured to generate a text embedding by selecting semantically similar parts of the written content obtained from one or more inputs and providing contextual information related to the written content. For example, when the user selects an issue (let's say economy), the LLM encodes in the form of a vector representation of the issue and utilizes only those parts for in-context learning for the LLM message creation whose semantic similarity with the issue is significant. Thus, the LLM may have custom definitions of what constitutes significant or “big enough”.

The LLM is further configured to create a draft text content based on user-chosen message topics/issues, already-written or published content, and content modifiers such as, but not limited to, selected from (i) from adding online information links to the message knowledge base, or (ii) selecting a theme/tone of the narrated video, selecting a preferred duration of video length, selecting a graphical-text quotation-frequency, selecting an average image/video segment screentime, composing an Opening Title sequence text-content, composing an End Title sequence text-content and selecting a final background music, to personalize the draft text with subsequent draft content modifiers as needed by a user to create a personalized summarized draft text content approved to the personal satisfaction of the user.

System 101 includes an AI text-to-audio Generator that combine information from the LLM, using unsupervised and supervised learning techniques, to generate an AI-narrated audio file from the verbatim or summarized text content with an user approved narration voice and narration type. In an embodiment, the AI text-to-audio generator determines the narration length of the generated AI-narrated audio file and divides the audio file length in time using an image screen-time modifier, by a predefined time interval, for example in a range of 3 to 5 seconds, to determine the number of images, graphics or video sequences required for the creating an AI-generated text-to-video file of a pre-determined length of time.

An image search engine is employed to search one or more multimedia databases for at least one of an image, a graphic, or a video segment that visually- and semantically-matches, is relevant to and in sync with the contextual information of the written content The image search engine uses LLM model with in-context learning to generate search keywords for searching one or more multimedia databases or the knowledge database for at least one of an image, a graphic, or a video segment that visually- and semantically-matches, and is also relevant to the contextual information and meaning of the related to the written content. Said LLM model includes an automated multimedia retrieval engine for parsing one or more multimedia websites, using Large Language Models (LLMs), and retrieving images, graphics, and video segments, wherein the multimedia retrieval engine scrapes various social media platforms and direct news links for effective image processing.

An AI-based text-to-graphics generator combines information from the large language model, using unsupervised and supervised learning techniques, to list the most semantically-relevant word phrases or sentences for user to choose, or for AI to automatically choose, to display as a colored, static-or-moving text-graphic in sync to and simultaneously with the spoken narrated audio words. In an alternate embodiment, the AI text-graphics generator determines the length of the generated AI-narrated audio file and divides the audio file length in time by a user-chosen quotation-frequency factor of either (a) the number of graphical text quotes to display per minute, or (b) display one text quote on every image or (c) on every predetermined number of images, for example, every 2-5 images in the video, to determine the timing and number of word-phrases/quotes needed to be overlayed in sync to the narrated video.

An AI-based video generator for synchronizing the generated AI-narrated audio file with at least one of an image, a graphic, or a video segment obtained by the image search engine that semantically matches to the contextual information to create and distribute an AI-generated video file by the user via email, and/or various social media platforms. The AI-based video generator automatically selects images, video segments, and graphical elements, that conveys a narrative aligned with the emotional and visual theme/tone relevant to the contextual information of the created AI-message.

As an example, a news item, a tweet, or any piece of text goes through the following flow:

Raw data->Instruction+LLM->Extracted Custom Data->Instruction+LLM->Part of politician's profile.

Then given an issue->text embedding->get semantically similar statistics, get parts of politician profile which are semantically similar (with encodings provided using the same model)->getting selected data->LLM+instruction+all other information such as tones, quotes, theme, and the like->Or about anything else.

In a further embodiment, the knowledge base is continually updated with images, graphics and video segments retrieved by the LLM model from continually searching various multimedia databases along with their contextual meaning to build a knowledge base of visual content with searchable key-word descriptions, allowing the creation of videos for distribution. The knowledge base is continually updated and stores images, graphics and video segments searched or retrieved by the LLM model that are identified, described, categorized, and labeled with one or more attribute descriptors, for example at least five attribute descriptors, selected from an action description, location setting, main subjects of the scene, mood/atmosphere, an event type, duration of the clip, time of the day, camera angle/shot Type, sound/music characteristics, color tone, lighting conditions, genre, language, special effects/visual enhancements, costumes/attire: descriptions, character interaction, directional movement, pacing, weather conditions, historical context, theme, props, background elements, sound effects, speech patterns, cinematography style, narration presence, scene transition, editing style, symbolism, cultural references, and other differentiating image characteristics to improve accuracy of future image searches for video clips and images to be used in videos.

In a further embodiment, the LLM uses facial recognition to generate and tag the name of the character and/or the people appearing in images featured in the video clips of a pre-determined time length, for example, 3 to 5-seconds video clip, stored in the knowledge base.

In an alternate embodiment, the LLM model assigns a value from 0 to 5 for each of the identified attribute descriptors to build the knowledge base.

In an embodiment, the process of extracting and categorizing scenes of a predetermined time, for example, 3 to 5 Second Scenes, by the LLM which are to be stored in the knowledge base includes the following steps

First, Video Access and Downloading that includes Tools such as python libraries like ‘youtube-dl’, ‘pytube’, or APIs for platforms like Facebook and program scripts to download the entire video from platforms like YouTube, Vimeo, or Facebook.

Next Video Segmentation that involves tools such as, OpenCV, ffmpeg wherein, for example, the ‘ffmpeg’ is utilized to segment the downloaded video into 3 to 5-second clips. Each segment is marked by time codes, ensuring each part of the video is covered.

Thereafter, Scene Detection is performed by leveraging advanced AI tools and frameworks to isolate specific scenes and evaluate each image/scene for one or more out of a plurality of descriptors, creating custom datasets where necessary to fine-tune multi-modal LLMs, and using tools such as Machine Learning models in TensorFlow or PyTorch trained for scene detection, and using LangChain and agent-based architectures to orchestrate multi-modal LLMs, ensuring seamless integration and processing for enhanced accuracy and relevance in descriptor extraction. The tools implement scene detection algorithms that identify transitions based on changes in the visual content (e.g., light and motion differentials) which help isolate key moments, such as the shark jumping out of the water in Jaws.

Next step involves Scene Detection and Descriptor Assignment-detecting specific activities through pose estimation using MediaPipe and object recognition with YOLOv10, building and utilizing a custom fine-tuned multi-modal LLM to contextualize and describe actions accurately, including the use of Tools such as NLP libraries (SpaCy, NLTK), Computer Vision libraries (OpenCV, TensorFlow) and other scene detection tools to detect Action (e.g., movement, object detection);

Next is Setting detection, which uses Detectron2 for object segmentation, Vision Transformers (ViT) for image classification, and Custom Multi-Modal LLM to identify the scene's location, detecting, categorizing, and labeling location settings such as urban, forest, or indoor, analyzing background elements to determine if the scene is underwater, urban, etc.,

Followed by Identifying the Main Subjects using YOLOv10 and Single Shot MultiBox Detector (SSD) for high-precision object detection to identify and categorize primary subjects like people, animals, or vehicles (e.g., shark),

Next is Mood/Atmosphere detection analyzes color histograms and lighting conditions using OpenCV to show visual tone (e.g., color grading) and employs a fine-tuned LLM to interpret emotional tones and atmospheres from visual data, with Sound/Music detection by analyzing the audio track for background sounds, music types, and dialogue using Whisper for transcription and Librosa/PyDub for audio feature extraction.

Thereafter, the process Scoring Descriptors using tools such as Custom Machine Learning models, LangChain Agents, YOLOv10, SSD, and the latest Multi-Modal involves training models to establish a standard for coring the intensity level of each descriptor on a scale, for example from 0 to 5. The model analyzes features like color intensity, object presence, and movement to assign scores.

The system also performs Time Code Identification utilizing tools such as Video analysis software (OpenCV). For a specific event (e.g., a shark jumping out of the water), pre-trained models are used to scan the entire video mark the exact time codes where the event occurs, and then add that Video Clip's Descriptive Title and list of relevant Descriptors by Intensity value.

Next is Copying and Saving Clips using tools such as ffmpeg. Once the scene is identified by time code, extract the clip of a specific pre-determined time length, for example, a 3 to 5-second clip, using ‘ffmpeg’ and save it as a new file.

Creating a Library and CMS Integration with tools such as Custom CMS, WordPress or Drupal for the user interface and storing the extracted and scored clips in a well-structured database. Ensure each clip is indexed with its descriptors and intensity scores.

Finally, Text-to-Video Matching, utilizing Tools such as Large Language Models (GPT-4, Gemini), that use LLMs to analyze input text and match keywords/phrases with video clips in the database based on the descriptors.

An example process for Extracting and Categorizing 3 to 5 Seconds from Shark Scene in Jaws is as follows:

1. Video Download: Script downloads Jaws from YouTube.

2. Scene Detection: Algorithm identifies the shark jumping scene through abrupt scene change, and high object activity using various types of scene detection methodologies and tools.

3 Segmentation: Video is segmented into 3 to 5-second clips.

4. Descriptor Assignment: —Action: “Shark jumps out of water” identified. —Setting: “Ocean” setting detected. —Main Subject: “Shark” recognized. —Mood/Atmosphere: Intense and terrifying mood analyzed. —Sound: Jaws theme music identified.

5. Scoring: Each of these elements is scored with a predetermined score, for example, from 0 to 5 since not every scene or video clip has every one of the 50 descriptor traits

6. Time Code: Script pinpoints the exact sequence length in seconds in the movie where the shark jumps.

7. Clip Extraction: ‘ffmpeg’ extracts the identified clip.

8. Library Storage: The clip is stored in CMS with other detailed descriptors and playback links to the video clip file.

9. Text Input to Video: LLM matches the “shark jumps out of water” keyword or semantic-image from text input to the stored clip and retrieves it.

The system 101 further includes an AI-based dynamic ad generator for the dynamical selection of a non-profit, corporate brand, family office foundation, or government sponsor-related advertisements that match the contextual information of the written content and incorporate the advertisements in the AI-generated video. Said AI-based dynamic ad generator creates placeholders within the AI-generated video during synchronization for incorporating sponsor-related advertisements. The placeholders may be generated at a pre-determined time interval within the AI-generated video, preferably at the beginning, the middle, and the end of the AI-generated video—for which users also receive Rewards for the video-viewership time they spend viewing the sponsors' advertisements, partially or in their entirety

The system 101 is further configured to calculate the user IP, and MacAddress connection time of the user to the video content created by the present invention, and, based on the amount of time streaming or playing the produced videos and advertisements, the user/viewer earns and is assigned reward points to their user account for every AI-generated video watched by the user on a given sponsored topic.

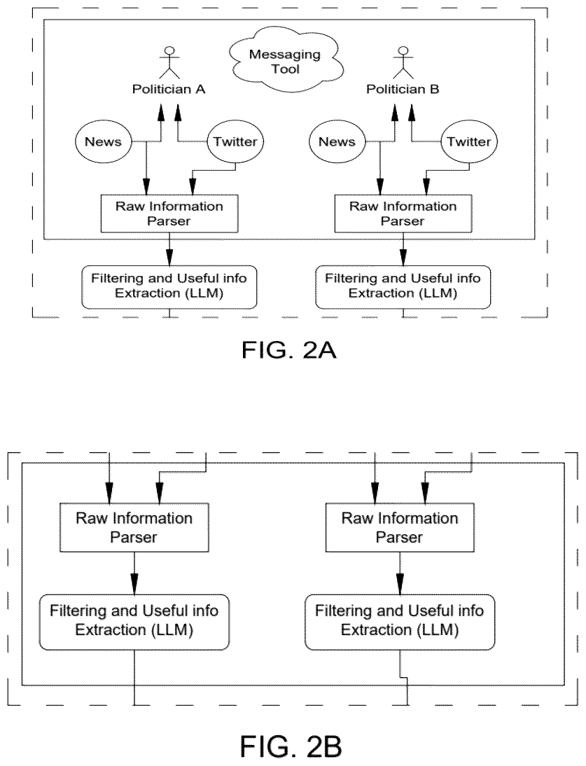

FIG. 2A illustrates a flow diagram of the system parsing and retrieving data from websites, according to an embodiment of the present invention.

System 101 uses a combination of AI-driven data retrieval from diverse sources using a pre-trained LLM and pre-trained embedding model algorithms and their combinations to retrieve the relevant data, dynamic Content generation, and user customization to ensure relevance and accuracy in delivering information to users. System 101 uses various data retrieval and parsing tools such as, but not limited to Selenium, Python, and the like, to automatically parse and retrieve data from a plurality of news websites such as, but not limited to, CNN™, Fox News™, MSNBC™, and the likes, and social media websites such as, but not limited to, Twitter™, Facebook™, and the likes. Said system 101 is configured to dynamically accept links to the official social media pages of a notable personality and/or the base search page of a news website, and extract raw information from the webpages.

For example, a plurality of modules are configured to extract relevant information from one or more websites such as a dynamic URL input module that accepts URLs to a politician's official social media page or the base search page of supported news websites. Further, the system uses in-context learning, where custom examples are presented to the network to perform specific tasks, such as extracting information from tweets or news articles, scraper modules that are configured for websites to ensure accuracy and effectiveness in data extraction; Infinite Scroll Handling module configured to automatically scroll down on websites or platforms that use infinite scroll mechanisms (such as Twitter™) to fetch more content; data extraction module that is configured to extract the raw content/information; user authentication module for authenticating and logging in social media accounts. An exemplary workflow of the above data extraction is provided below.

1. Initialization: The camping (AI GM) provides either a Twitter link or a news website link. #TODO candidate website
2. URL Detection: The system identifies the website from the given URL to determine which custom scraper to deploy.
3. Twitter Flow: If Twitter is detected, the scraper logs in using the provided credentials, begins scrolling to capture tweets related to the politician, and extracts raw tweet data (content, timestamp, likes, retweets, etc.)
4. News Website Flow: If a news website is detected, the scraper searches for the politician's name, and handles pagination or infinite scroll to capture relevant news links. For each detected news link, it navigates to the page and extracts raw news data (headline, content, author, timestamp, etc.)
5. Data Aggregation: Once all data is collected, it's aggregated into a structured format suitable for further analysis or storage.
6. Output: The aggregated data is then returned to the user or saved to a specified location.

In an exemplary embodiment, the technologies and libraries used by the system 101 may include selenium with Python™, compatible web drivers for various browsers, for example, ChromeDriver for Chrome™, GeckoDriver for Firefox™), beautiful soup to assist in parsing HTML content to extract data efficiently, python library for direct requests, and Python™ as the programming language for building the component.

FIG. 2B illustrates an exemplary workflow for parsing and retrieving data from different websites, according to an embodiment of the present invention. In an embodiment, system 101 is configured to generate one or more prompts specific to the details of the political candidate within system 101 to create a check on the gathered filtered information so that the information scope and relevancy are maintained. Said prompts may be related to the determination of the topic/issue related to a news story; followed by identifying if the determined issue is a political issue; determining the solution proposed by a political candidate identified in the news story; determining the opposing candidates' name and his/her solution; determine the impact of both the solution; identifying any legislative act mentioned in the news story; determine the party being represented by the political candidate; determine the stance of the candidate and the party and the likes. The system may retrieve, for the user, relevant information from the filtered information stored in the Knowledge Database 108 as described herein below:

“topic”: Identify the main topic of this news story.
“political_issue”: Identify any issue related to political or general population interests (taxes, debts, healthcare, guns, bills, etc.) mentioned in the news story?
“solution_proposed_by_{person_name}”: Summarize {person_name}'s proposed solution for the identified issue, if any.
“competitor_plan”: Summarize the plan or solution proposed by {person_name}'s competitor(s), if any. Distinguish clearly between {person_name}'s propositions and those of others.
“plan_impact”: If a solution from {person_name} or his competitor exists, evaluate its potential environmental, financial, and human effects.
“person_inference”: What can we infer about {person_name} from this news story?
“legislative_stance”: Are there any specific policies or legislative actions mentioned that {person_name} supports or opposes?
“supporters_and_opponents”: Does the news provide information about who supports or opposes {person_name} on these issues?
“public_reaction”: What are the public responses or reactions to {person_name}'s positions, as indicated in the news?
“comparison_with_opponents”: Does the news compare {person_name}'s positions with those of his potential opponents?
“party_stance”: Does the news mention {person_name}'s party's stance on these issues? If so, how does {person_name}'s position compare?
“controversial_aspects”: Are there any controversial aspects to the issues or {person_name}'s position on them?
“proposal_effects”: What are the effects of {person_name}'s proposal? Enumerate effects on environment, national debt, taxes, healthcare, etc.
“fact_checkable_statements”: Identify any statements from or about {person_name} that can be fact-checked. The statement has to be a quote of {person_name}.

In an embodiment, the users registered to the system 101 through the user devices 110 accessing the system through suitable web applications configured to connect with the server 106 having the system 101. The user may use the Profile Creation module of system 101 which provides efficient analysis and profiling based on diverse and dynamic news data. Said module is displayed on the user device 110 through the web application and is configured to receive structured information by utilizing advanced machine learning techniques to group data into coherent topics, thereby capturing nuanced insights for generating targeted messages by the system 101 and providing via the communication network 104 on user devices 110.

In an embodiment, the Profile Creation module employs the LLM and embeddings through pre-trained networks (utilizing the Sentence Transform library) to effectively group news items based on their extracted topics. Leveraging a Large Language Model (LLM), the system assembles comprehensive data by parsing aggregated information. This process encompasses various facets such as key issues, political stances, rival views, public reactions, and more.

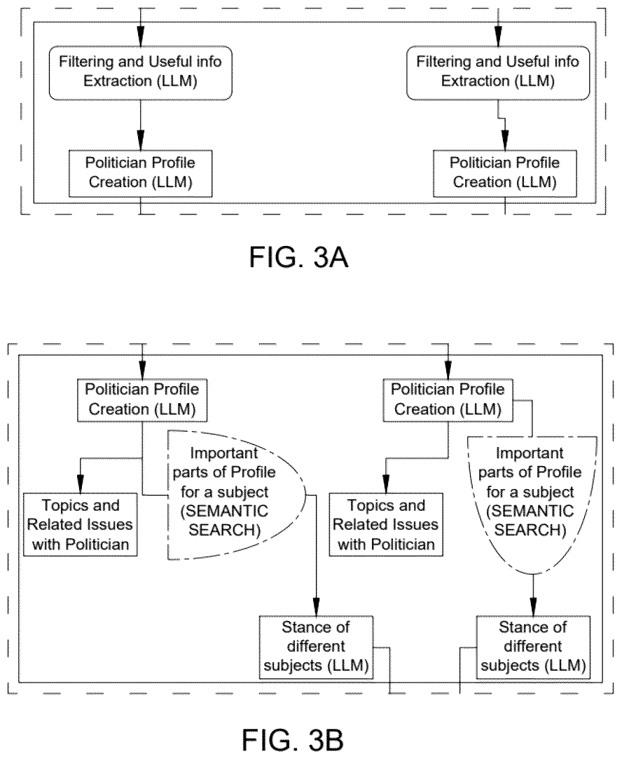

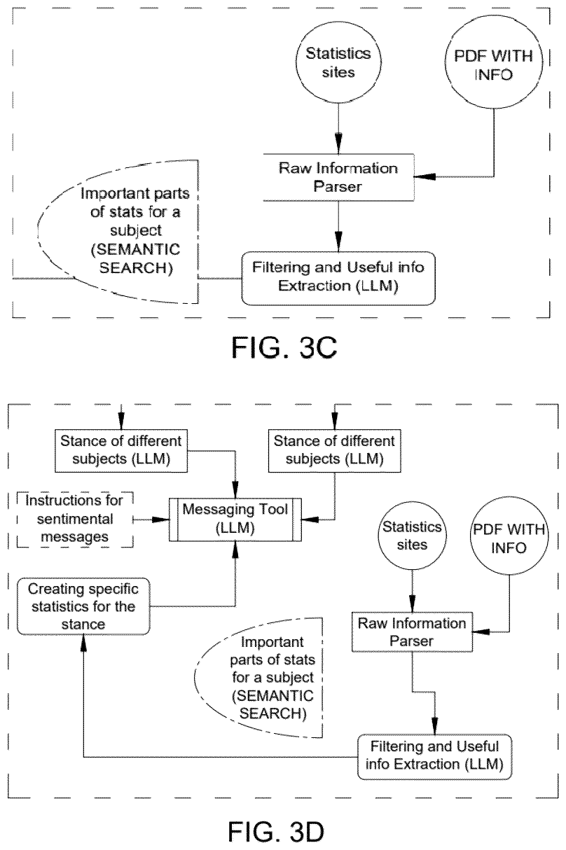

The workflow, key features, and technologies used in the profile creation module are described here below. However, the technological description provided here is to give a general description of the technical composition only as shown in FIG. 3A. Said Profile creator and aggregator receives structured information, and groups them by similar topics using machine learning techniques, thus creating detailed profiles of notable personalities. These captured profiles provide comprehensive insights about each personalities based on the aggregated news data, enabling quick interrogations and representing the base for the targeted message formulation. The profile creator and aggregator module includes but is not limited to Topic Grouping that uses clustering such as K-Means alongside embeddings via pre-trained networks, using the Sentence Transform library, to group news items based on their extracted topics. Profile Creation module configured to assemble detailed profiles of notable personalities based on the aggregated information. Said module utilizes an LLM to achieve this task. As an example, the various technologies and Libraries used in the present invention, but not limited to, Python as the primary language for building the component, Scikit-learn, and Sentence Transformer in Pytorch for grouping topics, LLM for grouping news data and creating the actual profiles. An exemplary workflow is provided below.

1. Data Input: The component receives structured information from the previous step.
2. Topic Grouping: Using machine learning embeddings and similarity metrics, news items are grouped by topics.

### 3. Profile Assembly:

Each politician's aggregated data is parsed.
For each identified topic related to the politician, the database structure is populated.
Key issues, political stances, rival views, public reactions, etc., are filled into the profile.
This process repeats for all politicians in the dataset.
   4. Database Storage: The assembled profiles are stored in a database, allowing for quick retrieval and interrogation.

In an embodiment, the system features module that excels in handling both broad topics and specific queries, utilizing Natural Language Processing (NLP) techniques for query understanding. The system seamlessly integrates custom query handling, profile segmentation, and Large Language Model (LLM)-assisted answering to deliver precise and relevant information to users. The module addresses challenges related to query ambiguity, accuracy, and data freshness, ensuring a sophisticated and reliable tool for users seeking prompt and accurate insights into political stances.

As an example, the technologies and libraries used in the present implementation include, but are not limited to, Python as the primary language for building the component; LLM for understanding the query, segmenting profiles, and deducing the politician's stance; Pytorch for encoding and understanding user queries. Below is an exemplary Workflow.

1. User Query Input: The user inputs a query related to a topic or specific event.
2. Query Encoding: NLP techniques (embeddings from pre-trained general-purpose models) are used to understand and encode the user's query, determining its essence.

### 3. Profile Selection:

The encoded query is matched against the stored politician profiles in the database.
Relevant profiles that might contain information about the query are selected.

### 4. Profile Segmentation:

Profiles are segmented into subsections.
Only the keynotes and most relevant subsections related to the query are retained. Here we use cosine similarity. This ensures concise and focused information.

### 5. LLM Processing:

The segmented profile information is fed to the LLM.
The LLM is asked to process only the provided segmented profile and deduce the politician's stance on the issue.
   6. Output Delivery: The LLM's response, which is the politician's stance on the queried topic, is presented to the user.

In an embodiment, system 101 incorporates a module Statistics Parser, a robust software module designed for extracting numerical information from diverse sources, with a focus on PDFs and websites. Leveraging various scraping libraries such as Beautiful Soup and Selenium for web parsing and specialized PDF extraction tools, the parser gathers raw data, which is subsequently processed by a Large Language Model (LLM) for classification, filtering, and selection of pertinent statistics with the automated web scraping, PDF data extraction, and LLM-assisted filtering. The workflow involves source identification, data extraction from web and PDF sources, preliminary data cleaning, LLM processing, and structured storage of relevant statistics addressing challenges related to dynamic websites, PDF variability, accuracy, data freshness, and handling rate limits or CAPTCHAs for extracting, filtering, and storing critical numerical data from various sources, ensuring its accurate functionality for downstream analysis or decision-making processes. The working, key features, and technological description statistics parser module are provided here as shown in FIG. 3C.

The Statistics Parser module is configured to extract numerical and related information from a range of sources, particularly PDFs and websites. The module, using a combination of Selenium for web parsing and specialized tools for PDF extraction, gathers raw data. The extracted raw data is then processed by a Large Language Model (LLM) to classify, filter, and select relevant statistics for further use. The Key Features of the module include but are not limited to a Web Parsing module with Selenium configured to automate the scraping of websites to gather statistical data, a PDF Extraction module configured to extract statistical data from PDF documents, an LLM-Assisted Filtering module that is configured to use an LLM to discern the relevance and usefulness of the gathered statistics.

In an exemplary embodiment. various technologies and libraries used in the present module are, but not limited to, Python as the primary language for building the component; Selenium for web scraping and data extraction from web sources; PyPDF2 for extracting data from PDF documents; LLM for classifying and filtering the extracted statistical data; Dynamic Websites for websites with dynamically loading content that may pose challenges for standard Selenium scripts; PDF Variability for PDFs that may vary in their structures, making universal extraction challenging; Accuracy for ensuring the accuracy and relevance of the extracted data is paramount since misinterpretation can lead to incorrect conclusions; Data Freshness for Periodic re-scraping or re-checking might be necessary to keep the statistical data up-to-date; Rate Limits and CAPTCHAs for some websites that may have measures against frequent automated requests, such as handling CAPTCHAs or respecting rate limits is essential. A sample Workflow of the module is provided below.

1. Source Identification: The system is directed towards specific URLs or given PDF documents containing potential statistical data.

### 2. Data Extraction:

For Web Sources: Selenium scripts navigate the targeted websites, scraping data from tables, infographics, or text content.
For PDFs: Specialized libraries (like PyPDF2 or PDFMiner) parse PDF contents to extract statistical information.
   3. Preliminary Data Cleaning: Basic cleaning operations are applied to the raw data to remove any obvious noise or irrelevant information.

### 4. LLM Processing:

The cleaned data is passed to the LLM.
The LLM classifies the data, determining its relevance and importance based on predefined criteria.
Useless or irrelevant statistics are filtered out.
   5. Output Storage: The selected relevant statistics are stored in a structured format in a database or passed on to subsequent modules for further processing.

In an embodiment, the present system 101 crafts persuasive messages, meticulously generated to capture the attention of users, appeal to their sense of facts, and present practical solutions to pressing issues. By harnessing the potential of social media and AI the messages are generated in a manner as described below and shown in FIG. 3D. The Messaging Engine/module is configured to synthesize cohesive and targeted messages based on the input, relevant statistical data, and a series of additional user-defined settings. This component intelligently crafts messages that are not only informative but also tailored to the desired tone, theme, and directives provided, ensuring that the output aligns with the strategic communication goals of campaigns or discourse analyses. The key features of this module include, but are not limited to, Stance analysis wherein the module is configured to interpret and integrate plurality of topics. Another feature of the said module is statistical incorporation for embedding relevant statistical data to support. The module is also configured to customize the tone and theme that adapts to the message such as, but not limited to, emotional, patriotism, and the likes, and themes such as, but not limited to showcasing leadership, vote encouragement, community care, and the likes per user instructions. The module is further configured for custom user instructions compliance wherein the module follows specific guidelines set by the user to target particular demographics or address specific points of interest. As an example, the various technologies and libraries used in the present modules may include, but are not limited to, Open-AI LLM for parsing and understanding and integrating statistics meaningfully, preferably, LangChain; AI Text Generation Algorithms to produce the base layer of the messages that sound natural and are coherent; Custom Scripting for applying additional settings such as tone and theme. An exemplary workflow of the modules is provided below:

### 1. Input Gathering:

Receives the politicians' stances on selected topics.
Collects pertinent statistics that align with the topics of discussion.
Accepts additional parameters like tone, theme, and custom user instructions.

### 2. Content Synthesis:

Analyzes the input data using natural language processing to understand context and content.
Structures the message, considering the best use of statistics to support or compare the politicians' viewpoints.

### 3. Customization:

Applies the desired tone and theme to the message, ensuring the delivery is on-brand with the campaign or analysis purpose.
Adheres to custom instructions which may include targeting certain demographics, emphasizing particular points, or avoiding sensitive subjects.

### 4. Message Generation:

Generates a draft message that is coherent, contextually relevant, and aligned with the provided data and settings.
Reviews the message for logical consistency and factual accuracy.

### 5. Output Delivery:

Presents the finalized message in a format ready for distribution across various platforms or for further review by campaign staff or analysts.

In an embodiment, the system incorporates an output message format which provides the user the liberty to generate and distribute messages in multiple formats including a Text-based Message format, Text-to-Audio Narrated Message format, and Text-to-Audio Narrated Video Message Format as per the user.

In an embodiment, the AI Message Generator further incorporates a methodology for ascertaining the requisite number of visual images essential for the Text-to-Audio Narrated Video Message Format. This determination is contingent upon the duration of the original Text-Based Message's narration and a prescribed average image-screen-duration of 3 seconds during playback.

In an embodiment, the system adeptly computes the temporal extent of the original Text-Based Message's narration in seconds and minutes, employing an average spoken text-to-voice enunciation. The User-Selected Image Screen Time augments the user's interaction by allowing them to discerningly choose an average number of seconds for the display of each image during the initial editing cut of the video. This personalized input directly influences the subsequent Approximation of Image Count, where the system precisely calculates the approximate number of images required based on the user-specified average image screen time ensuring a tailored and user-driven video creation process.

In an embodiment, the system Utilizes the Knowledge Base, wherein the system strategically employs issue-related images, graphs, tables, and other visualized statistics sourced from each message's aggregated and saved Knowledge Base ensuring that the visual components of the video are rooted in the specific context and content of the messages created within the system.

In an embodiment, the system further includes an Extended Image Search, where the system autonomously explores additional images, graphics, tables, and visual statistics beyond the Knowledge Base. This expanded search is aligned and synced with the visual relevance to the meaning of the Narrated Message, its theme, and the matched words, phrases, and sentences, further incorporating the external visual elements and enriching the diversity, depth, and viewer appeal of the video content.

In an embodiment, the system dynamically generates a compilation of images synchronized with the length of the narration, accounting for the user-inputted average image screen time, thus enhancing the system's ability to seamlessly integrate visual elements with the narrative flow of the message. Users can further modify the screen time length of each image, delete images, and thereby craft revised, user-approved saved videos. Upon saving user-edited videos, the system preserves a library/record of image links/locations for future use in Message Visualizations. This interactive user involvement enhances the adaptability and customization potential of the system.

Another embodiment of the present invention discloses an automated process of compiling and displaying relevant visual images from online resources; graphs, charts, and tables from the Knowledge Base resources used in the creation of the text-based message; and available video-segments from online resources that are combined into a First-Cut Video for which the user can change the screen-time length and order of the compiled images to create an Issue-oriented short-form Documentary-style Video of images that are relevant to the words/phrases/meaning and issue/theme/tone of the text-based message, and timed exactly to accompany the user-selected text-to-voice audio narration.

Through this, the user-creation/production of a message video is simplified by having an automated system to generate for the user an already-assembled video sequence of images to match the narrative text, which the user can re-edit by changing the duration of the images, deleting or adding images, re-ordering images and applying all final edits to the narrated audio track, music soundtrack (if any), image transition effects (pans, zooms, wipes) and onscreen graphical text and video content.

In an embodiment, the user, through his or her smartphone can create an audio or video of the user narrating the messages created by the instant AI Messaging system in the user's voice, with the user recording themselves, reading/saying the message on-camera. This inventive step of using the Message as a narrative script to match images that best convey the meaning of the message's words/phrases/sentences effectively closes the loop on the entire messaging process by enabling users to create short video documentaries on the issues being promoted in the messages that were originally composed in text format.

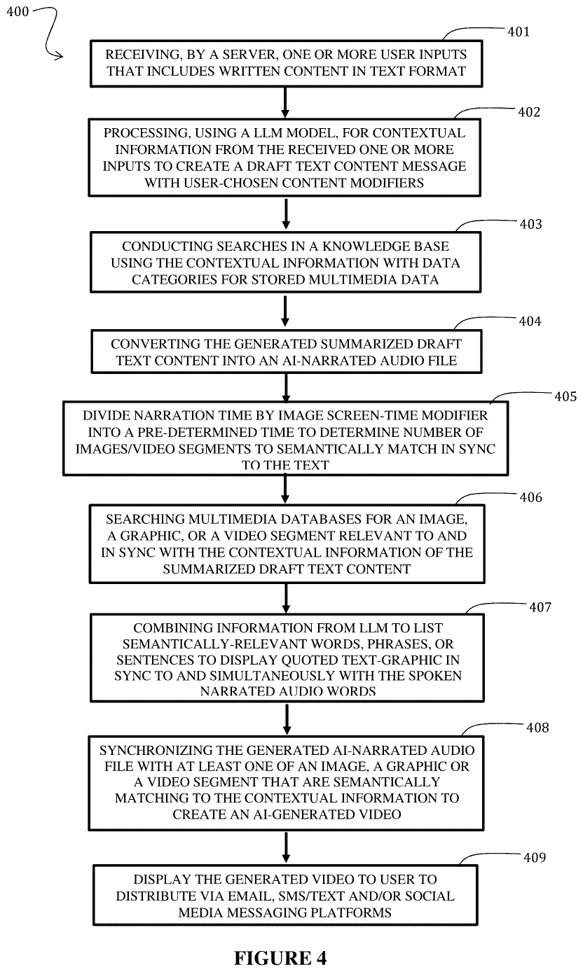

FIG. 4 illustrates a Flow Diagram 400 depicting the workflow of generating a personalized text-to-video message using AI. The computer-implemented method for generating text-to-video messages using an AI-based system is interfaced with a Knowledge Base over a network. The method, at step 401, receives one or more user inputs, like a source of user-selected written content input in text format, document file format, website address, or webpage address of content for semantically-summarizing by AI and converted into a narrated video. Alternatively, this step includes input of text and web content addresses and search-results into the Knowledge Base of text, images, video segments, graphics, modifiers, and search results for subsequent text-to-video conversions. Additionally, the step includes user-selected average screen-time (number of seconds) per video image; user-selected quotation-frequency of visual-text quotes to be displayed in the video per minute, or visual quotes to be displayed over every image or every pre-set number of images, for example, every 2-5 images throughout the video.

In step 402, the system utilizes a large language Model or LLM with in-context learning using examples from data in the Knowledge Base to process contextual information from the received inputs into creating a draft text content message of topics/issues already-written or published content, and content modifiers, considering user-chosen average screen-time (number of seconds) per video image; or user-selected quotation-frequency of visual-text quotes to be displayed in the video per minute or visual quotes to be displayed over every image or every pre-set number of images, for example, every 2-5 images throughout the video. In an embodiment, the content modifiers are selected from the narrated length of the message, additional message subject, including power-point-like slides, charts, and graphs, or statistics, to be included from the Knowledge Base, average screen time per image/video segment, and read-along text graphic for every pre-determined number of images, for example every 1-5 images, composition of the Opening Title sequence text-content and End Title sequence text-content and selecting the final background music.

In an embodiment, graphs may include but are not limited to, PowerPoint-like slides, charts, visual graphs, and the like, that users can easily comprehend. Further, the statistical data may be obtained from online databases such as USCensus.gov, FRED federal reserve economics data, Whitehouse.gov, House and Senate websites, Pew Research, top opinion polling companies, and the like.

In an embodiment, the content modifiers are selected from (i) adding online information links to the message knowledge base, or (ii) selecting a theme/tone of the narrated video, selecting a preferred duration of video length, selecting a graphical-text quotation-frequency, selecting an average image/video segment screentime, composing an Opening Title sequence text-content, composing an End Title sequence text-content and selecting a final background music.

At step 403, system 101 conducts searches in the Knowledge Base using the contextual information with data categories, like subject-based data, people-based data, geospatial-location data, financial/transactional data, sensor data, non-numeric qualitative data, numeric quantitative data, administrative data, and behavioral data, in text format, in image/video clip format and statistical chart/table/graph format from governmental, educational, corporate, non-profit organization and private online resources from one or more multimedia websites.

In Step 404, the method converts, using an AI-based text to audio generator, the generated summarized draft text content into an AI-narrated audio file from the verbatim or summarized text content with a user-approved narration voice and narration type.

In step 405, the method, divides the narration time of the user-approved narration voice using an image screen-time modifier into a predetermined time length, for example, 3-5 seconds, to determine the number of images/video segments to semantically match in sync to the text.

In step 406, the method using one or more keyword searches, using an image search engine that uses an LLM model, one or more multimedia databases for at least one of an image, a graphic, or a video segment that visually- and semantically-matches, is relevant to and in sync with the contextual information and meaning of the summarized draft text content. Large Language Models (LLMs) with in-context learning generate search keywords for searching one or more multimedia databases for at least one of an image, a graphic, or a video segment that visually- and semantically-matches and is relevant to the contextual information and meaning of the written content. The LLM analyzes key phrases, keywords, concepts, topics, and semantic structures, leveraging its understanding of context to create refined and optimized search terms. This process enhances the relevance of search outcomes, particularly in applications such as multimedia synchronization, information retrieval, and content curation.

In an alternate embodiment, the searching is driven by semantic analysis of AI-narrated audio files and is performed to understand the emotional and contextual information to find relevant images, graphics, and/or visual segments matching the LLM search terms. These visuals are chosen to complement the AI-generated narration, enhancing the overall impact of the AI-message. This step ensures that visually engaging and consistent with the user's preferences and the subject matter of the generated AI-message.

In step 407, the method combines, using an AI-based text-to-graphic generator, information from the LLM, to list the most semantically-relevant word phrases or sentences for the user to choose, or for AI to automatically choose, to display as a colored, static-or-moving text-graphic in sync to and simultaneously with the spoken narrated audio words. The step of combining further includes determining the length of the generated AI-narrated audio file and dividing the audio file length in time by a user-chosen quotation-frequency factor selected from the number of graphical text quotes to display per minute, display one text quote on every image, or display on every pre-set number of images, for example, every 2-5 images in the video, to determine the timing and number of word-phrases/quotes needed to be overlayed in sync to the narrated video.

In step 408, the method, using an AI-based video generator, synchronizes the generated AI-narrated audio file with at least one of an image, a graphic, or a video segment that visually matches the contextual information and meaning of input text to create an AI-generated video file for the user. The AI-generated narration is synchronized with the selected images, graphics, and video segments to create a seamless and cohesive video. This involves aligning the timing of the visuals with the narration so that the images and videos appear in sync with the spoken content. The method calculates the appropriate transitions between visuals based on the narration's length and pacing, ensuring that each visual element corresponds to the relevant part of the message. This synchronization process enhances the overall coherence and engagement of the video, delivering an immersive and impactful experience for the user. This step further includes determining the narration length of the generated AI-narrated audio file and dividing the audio file by a predefined time interval, using an image screen-time modifier, for example in a range of 3 to 5 seconds, to determine the number of images, graphics, or video sequences required for the AI-generated video file.

In an alternate embodiment, system 101 displays contextually matching one or more images, graphics, and/or video segments, preferably 5-20 options, to the user along with the AI-narrated audio files, requiring approval from the user. This allows the selection of the desired audio narration, and semantically-similar images, video segments, and/or graphical elements, for overlaying with the AI-narrated audio file. By providing these customizable options, the system enables professional creative directors to have more hands-on creative input, allowing them to tailor the content to the users' vision. This level of involvement not only enhances the quality of the final product but also offers directors personal credit, satisfaction, and potential compensation for their contributions.

In step 409, system 101 displays the fully generated video to the user on their device. This video includes the AI-narrated audio synchronized with the selected images, graphics, and video segments. The user can now watch the personalized video, which presents the message in a visually engaging and coherent manner.

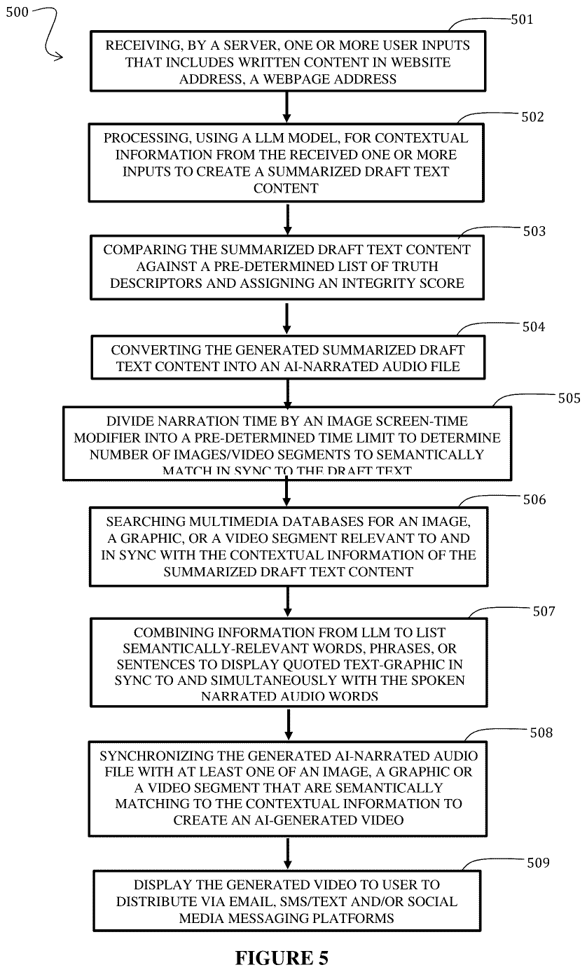

FIG. 5 illustrates a Flow Diagram 500 depicting a workflow of detecting the integrity of information using a pre-determined list of truth descriptors, according to an embodiment of the present invention. The computer-implemented method for analyzing one or more contents in a website utilizes an AI-based system interfaced with a Knowledge Base over a network. The method, at step 501, receives one or more user inputs, like a like a website address, a webpage address, web content addresses, or search-results of text, images, video segments, or graphics for semantically-summarizing by AI and analyzing the integrity of the content of the website against AI-generated list of truth descriptors that are based on information from one or more reliable news media and/or one or more fact-checking databases.

In step 502, the system 101 utilizes a large language Model or LLM with in-context learning using examples from data in the Knowledge Base 108 to process contextual information from the received inputs into creating a summarized draft text content message of topics/issues already-written or published content.

At step 503, system 101 compares the contextual information of the summarized draft text content against a pre-determined list of truth descriptors in the Knowledge Base 108 and assigns an integrity score for the summarized draft text content based on the comparison results. Additionally, the process provides a feedback to the user on the integrity of the summarized text based on the generated integrity score, that indicates the degree of accuracy and reliability of the user-input. Table 1 lists different categories of truth descriptors along with their analysis method by the AI-based evaluator.

TABLE 1
Truth Descriptors

| S. | Category/ | Determination | Analysis performed by |
|---|---|---|---|
| No. | Classification | Result | the AI-based evaluator |
| 1 | Fake | Completely | Based on a |
| | | false | comparison of the |
| | | | information/content |
| | | | received against one or |
| | | | more verified sources or |
| | | | fact-checking databases |
| | | | to determine |
| 2 | False | Contradicts | Based on a cross- |
| | | official | reference of the |
| | | records, | information/content |
| | | laws, or | with official records, |
| | | scientific | legal documents, |
| | | studies | and peer-reviewed |
| | | | scientific studies |
| 3 | Misleading | Truth-based | Based on analyzing |
| | | but twisted | the context and |
| | | from the | language used to |
| | | intended | detect intentional |
| | | meaning | distortion. |
| 4 | Unproven/No | No existing | Based on searches for |
| | Basis | evidence to | corroborative evidence in |
| | | prove or | reliable sources, noting |
| | | disprove | the absence of |
| | | | verifiable data. |
| 5 | Inaccurate | Inaccuracies | Based on verification |
| | | in dates, | of the numerical |
| | | figures, or | data in the |
| | | other numbers | information/content |
| | | accompanying | against official |
| | | the | statistics and |
| | | information. | records to identify |
| | | | discrepancies. |
| 6 | Needs Context | Lacks crucial | Based on an examination |
| | | context | of the broader context |
| | | | surrounding the |
| | | | information/content, |
| | | | including historical and |
| | | | situational factors. |
| 7 | Flip-Flop | Shift in a | Based on comparison |
| | | public | of the information/content |
| | | figure's | against a tracking of |
| | | stance on | public statements |
| | | a specific | and policy |
| | | policy or | changes to detect |
| | | issue | inconsistencies. |
| 8 | Unsubstantiated | Rumors or | Distinguishes between |
| | | hearsay | rumors and verified |
| | | without | information by checking |
| | | solid | the source reliability. |
| | | evidence | |
| 9 | Partially True | Elements | Separates factual elements |
| | | of truth | from false ones and |
| | | mixed with | highlights both in the |
| | | falsehoods | analysis. |
| 10 | Overgeneralization | Broad | Identifies and assesses |
| | | statements | the specificity of the |
| | | that lack | information/content, |
| | | specific | highlighting any lack |
| | | evidence | of detailed support. |
| 11 | Speculative | Based on | Distinguishes speculation |
| | | conjecture | from verified information |
| | | rather | by assessing the |
| | | than fact | evidentiary support. |
| 12 | Anachronistic | misplaces | Cross-references timelines |
| | | events or | to ensure historical |
| | | information | accuracy. |
| | | in the | |
| | | wrong time | |
| | | period | |

Table 1 includes the categories of the truth descriptors that are stored in the knowledge database 108 and continually updated. In an alternate embodiment, the AI-based evaluator may include additional truth descriptors or may include sub-categorise to accurately define an information/content.

The AI-based evaluator, based on the analysis, automatically generates a blacklist of websites whose contents falls withing the categorized truth descriptors along with a summary of the rumors and conspiracy theories circulating on such sites. The AI-based evaluator rejects any information from the identified blacklisted websites and uses the corresponding summary to create counter-narratives, presenting verified facts to dispel misinformation. In an alternate embodiment, the AI-based evaluator summarizes content from these blacklisted sites to create a list, for example, Top 25 or Top 50 list, of Fact-Checked lies and conspiracies. This list is used to generate one or more AI text-to-video that refute misinformation with verified facts.

In Step 504, the method converts the generated summarized draft text content, using an AI-based text to audio generator, into an AI-narrated audio file with a user-approved narration voice and narration type. In step 505, the method, divides the narration time of the user-approved narration voice using an image screen-time modifier into a pre-determined time length, for example 3-5 seconds, to determine the number of images/video segments to semantically match in sync to the draft text content.

In step 506, the method using one or more keyword searches, using an image search engine that uses an LLM model, one or more multimedia databases for at least one of an image, a graphic, or a video segment that visually- and semantically-matches, is relevant to and in sync with the contextual information and meaning of the summarized draft text content. Large Language Models (LLMs) with in-context learning generate search keywords for searching one or more multimedia databases for at least one of an image, a graphic, or a video segment that visually- and semantically-matches and is relevant to the contextual information and meaning of the written content. The LLM analyzes key phrases, keywords, concepts, topics, and semantic structures, leveraging its understanding of context to create refined and optimized search terms.

In step 507, the method combines information from the LLM, using an AI-based text-to-graphic generator, to list the most semantically-relevant word phrases or sentences for the user to choose, or for AI to automatically choose, to display as a colored, static-or-moving text-graphic in sync to and simultaneously with the spoken narrated audio words. The step of combining further includes determining the length of the generated AI-narrated audio file and dividing the audio file length in time by a user-chosen quotation-frequency factor selected from the number of graphical text quotes to display per minute, display one text quote on every image, or display on every pre-set number of images, for example, every 2-5 images in the video, to determine the timing and number of word-phrases/quotes needed to be overlayed in sync to the narrated video.

In step 508, the method synchronizes the generated AI-narrated audio file, using an AI-based video generator, with at least one of an image, a graphic, or a video segment that visually matches the contextual information and meaning of input text to create an AI-generated video file for the user. The AI-generated narration is synchronized with the selected images, graphics, and video segments to create a seamless and cohesive video. This involves aligning the timing of the visuals with the narration so that the images and videos appear in sync with the spoken content. The method calculates the appropriate transitions between visuals based on the narration's length and pacing, ensuring that each visual element corresponds to the relevant part of the message. This synchronization process enhances the overall coherence and engagement of the video, delivering an immersive and impactful experience for the user. This step further includes determining the narration length of the generated AI-narrated audio file and dividing the audio file by a predefined time interval, using an image screen-time modifier, for example in a range of 3 to 5 seconds, to determine the number of images, graphics, or video sequences required for the AI-generated video file.

In an alternate embodiment, system 101 displays contextually matching one or more images, graphics, and/or video segments, for example 5-20 options, to the user along with the AI-narrated audio files, requiring approval from the user. This allows the selection of the desired audio narration, and semantically-similar images, video segments, and/or graphical elements, for overlaying with the AI-narrated audio file. By providing these customizable options, the system enables professional creative directors to have more hands-on creative input, allowing them to tailor the content to the users' vision. This level of involvement not only enhances the quality of the final product but also offers directors personal credit, satisfaction, and potential compensation for their contributions.

In step 509, system 101 displays the fully generated video to the user on their device. This video includes the AI-narrated audio synchronized with the selected images, graphics, and video segments. The user can now watch the personalized video, which refutes the false information with verified facts in a visually engaging and coherent manner.

The foregoing method counteracts misinformation, using an AI-driven Fact-Check and Truth-Reliability component that can be integrated into any text-to-video service. This system would use a blacklist of websites known for spreading fake news, as reported by third parties.

An example method for analyzing the integrity of one or more contents in a website includes a step of Content Analysis wherein the AI scans blacklisted websites and summarizes their content to identify key rumors, conspiracy stories, and lies.

A step of Fact-Checking, using Large Language Models (LLMs), wherein the AI compares these summaries against reliable sources, such as academic databases, government records, and verified news outlets. The AI builds and continually updates the Knowledge Base with reliable sources, including government records, academic publications, and verified news outlets. The AI also monitors and updates the blacklist of websites known for spreading misinformation, summarizing their content to identify prevalent falsehoods. In a further embodiment, the AI cross-references content from blacklisted websites with the Knowledge Base to evaluate the accuracy of claims.

The AI then categorises the content using the Truth Descriptor as disclosed in Table 1, wherein the AI evaluates the degree of truthfulness or falsity of each story using the predefined Truth Descriptors. The AI applies the Truth Descriptors to rate the veracity of each information/content with a predetermined rating score, creating a clear and concise analysis.

Finally, content creation based on the analysis and summarized text content, wherein the system generates text-to-video content that debunks false claims and presents verified information in an engaging video format. The AI generates engaging videos that present accurate information and refute misinformation, using visual and audio elements to enhance comprehension and retention.

In an embodiment, the AI generated summarized text includes information from the Knowledge Base that has been updated with pre-screened and graded using the pre-determined list of Truth Descriptor for reliability, accuracy, and source reputation of the information, and reject any information having integrity score lower that a predetermined integrity score from the Knowledge Base. Further, the system 101 dynamically monitors and updates the generated Blacklisted websites and associated Truth Descriptor Intensity scores for preventing any information from the Blacklisted websites for inclusion in the Knowledge Base, to ensure the Knowledge Base remains free of false or unreliable data and maintain credibility of AI-generated summaries and outputs.

In a further embodiment, the method provides the creation of placeholders, using an AI-based dynamic ad generator, within the AI-generated video during synchronization for incorporating sponsor-related advertisements and dynamical selecting sponsor-related advertisements that match the contextual information of the draft text content for incorporating in the created placeholders. The system 101 provides integration of targeted advertisements within the final videos to maximize revenue potential. The system 101 allows to the user select advertising placements for both local and national sponsors' videos, which are tailored to the location of the user. Advertisements can be inserted before, during, or after each video, with the option to include QR codes that link visually to sponsor content, enhancing engagement and interaction between users and advertisers.

In an embodiment, the system 101 AI-based dynamic ad generator includes dynamic Ad Insertion (DAI) technology that revolutionizes the way ads are integrated into video content, providing a seamless, TV-like experience without interruptions or buffering. The system determines the placement of sponsors' video players, ad spaces, banners, buttons, or links within the AI-generated video optimizing visibility for sponsors. The DAI stitches ads directly into live linear programming and video-on-demand streams, bypassing the need for separate ad requests and reducing client-side errors. The system then outputs the approved final version, which includes the sponsor banners or advertisements placed at the selected location. This integration ensures smooth content delivery with minimal latency, creating a superior viewing experience. In a further embodiment, the DAI enables personalized, targeted advertising by analyzing viewer profiles and preferences, enhancing the relevance and effectiveness of ads.

In a further embodiment, custom and specialized datasets that encompass diverse visual, audio, and contextual elements will fine-tune multi-modal LLMs, ensuring they capture nuanced descriptor details effectively; Vector databases (e.g., Pinecone, FAISS) will store and query semantic embeddings, enhancing the retrieval and contextual understanding capabilities of the system; and the latest transformer-based models will be incorporated for both vision and language tasks to ensure state-of-the-art performance in descriptor extraction and interpretation.

Additionally, the DAI provides detailed analytics and reporting, tracking metrics such as ad viewability, completion rates, and viewer engagement. These insights allow publishers and advertisers to refine their strategies, resulting in improved ROI. To further maximize revenue potential, the system offers multiple advertising pricing models, including Cost Per Mille (CPM), Cost Per Completed View (CPCV), Cost Per Click (CPC), and Cost Per Acquisition (CPA). These models enable precise targeting, ensuring that publishers and advertisers can track the effectiveness of their campaigns.

The present invention also provides substantial benefits to both publishers and educational institutions by offering a dynamic system that transforms written content into personalized, engaging videos. Tailored to the digital consumption habits of younger generations, this system enables traditional media to reclaim lost readership while ensuring the content remains credible and factually accurate, especially in politically sensitive topics. By delivering information in video format, the invention aligns with the preferences of modern audiences, making content more accessible and relevant.

The system enables publishers to meet the rising demand for video-based news by converting written articles into engaging digital content, attracting younger audiences on platforms like TikTok, YouTube, and Instagram. This shift boosts reader engagement and expands viewership, while also generating new revenue through advertising, sponsorships, and partnerships. AI-driven video creation ensures fact-based, visually appealing content with lower production costs, and advanced analytics help refine content strategies. Collaborations with influencers and the integration of product placements or branded merchandise further enhance revenue potential.

For Educational Institutions, the system transforms how educational content is delivered by using AI-generated videos to enhance student engagement and understanding. The video format supports various learning styles, making education more accessible for students who may struggle with traditional text-based methods or prefer visual and auditory learning. This is especially helpful for students with low reading comprehension or learning disabilities.

In addition to its educational benefits, the system incorporates advanced user-tracking and profile-creation features, enabling detailed monitoring of student activities. Schools can track how long students watch videos, what content they interact with, and who they share it with. These features are essential, for example, for video Student Rewards Programs, which incentivize learning by rewarding students with points for page views and time spent on educational videos. The rewards tracking and certification system ensures that students are credited for their participation, offering an innovative way to motivate and certify learning progress while creating opportunities for further monetization.

By integrating a robust Fact-Check and Truth-Reliability component, the AI-powered system will not only combat misinformation but also promote media literacy among viewers. The described system will ensure that the content consumed by the TikTok/Instagram/YouTube generation is accurate and reliable, supporting a more informed and engaged public. With the expanded list of Fact-Checking Descriptors and AI Evaluators, the service provides a higher degree of accuracy in content analysis and descriptor creation, ultimately enhancing the credibility and impact of the news presented.

In conclusion, incorporating this advanced fact-checking system will be a crucial step towards ensuring that digital news consumption remains truthful and informative, fostering a well-informed citizenry and protecting the integrity of democratic processes.

While for purposes of simplicity of explanation, the illustrated methodologies are shown and described as a series of blocks/steps, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and the illustrative examples shown and described. Thus, this application is intended to embrace alterations, modifications, and variations that fall within the scope of the appended claims.

The methodology and techniques described for the exemplary embodiments can be performed using a machine or other computing device within which a set of instructions when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client-user machine in a server-client-user network environment, or as a peer machine in a peer-to-peer (or distributed) network environment.

Moreover, although the present invention and its advantages have been described in detail, it should be understood that various changes, substitutions, and alterations can be made herein without departing from the invention as defined by the appended claims. Moreover, the scope of the present application is not intended to be limited to the particular embodiments of the process, machine, manufacture, and composition of matter, means, methods, and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

The preceding description has been presented with reference to various embodiments. Persons skilled in the art and technology to which this application pertains will appreciate that alterations and changes in the described structures and methods of operation can be practiced without meaningfully departing from the principle, spirit, and scope.

What is claimed is:

1. A computer-implemented system for generating documentary-style multimedia content from textual input, comprising:
a processor configured to:
determine total narration duration from received narrative content, wherein the narrative content comprises any of: single narrator text, multi-speaker dialogue, interview transcripts, or hybrid documentary formats;
calculate a required number of visual elements R using a mathematical formula that divides the narration duration by a display time parameter to determine the exact quantity of visual elements needed for synchronized presentation;
select exactly R visual elements from multimedia databases based on semantic relevance to the narration;
a user interface configured to receive one or more inputs, comprising narrative content in script format, digital documents, or network addresses, wherein the inputs are used for automated processing, summarization, or transformation into multimedia content and further configured to receive user-defined parameters for controlling visual or timing aspects of the generated content, including a user-selected display time parameter representing seconds per visual element, wherein the display time parameter is selectable within a range of 2-5 seconds corresponding to documentary pacing standards;
at least one pre-trained large language model (LLM) configured to receive one or more inputs and generate processed textual output based on contextual analysis, wherein the language model is trained or fine-tuned using data from a knowledge base comprising structured and unstructured content from diverse sources including pre-existing verified images and video segments;
a pre-trained embedding model configured to analyze the input content and identify semantically relevant segments to enhance contextual understanding, wherein the language model utilizes the contextual information to generate a personalized draft text based on user-selected topics, existing source material, and customization preferences;
an AI text-to-audio Generator combining information from the large language model, using unsupervised and supervised learning techniques, to create an AI-narrated audio file from the verbatim or summarized text content, wherein the text-to-audio generator:
determines the total narration duration N regardless of whether the narrative includes single or multiple speakers;
identifies time-based transition points and speaker changes in multi-voice narratives;
applies one or more user-selected content modifiers, including narration voice and narration type, where narration type includes single-narrator documentary, interview-based documentary, or dialogue-driven documentary formats;
a visual media search engine configured to:
search one or more multimedia databases for visual elements comprising images, graphics, or video segments that semantically-match and are relevant to the contextual information and meaning of the narrated content;
for multi-speaker narratives, perform speaker-specific semantic matching to retrieve visual content appropriate to each speaker's words;
retrieve and score candidate visual elements based on semantic relevance;
provide exactly R highest-scoring visual elements as determined by the mathematical formula, where visual elements include both still images and video segments of approximately 3-5 seconds duration;
an AI-based text-to-graphics generator configured to identify and display semantically relevant textual elements as visual overlays in synchronization with the narrated audio, wherein the visual overlays comprise stylized static or animated text elements selected automatically or by user input, including speaker identification for multi-voice narratives; and
an AI-based video generator configured to: assemble the exactly R selected visual media elements (images and/or video segments) in sequence;
display each visual element for the display time parameter to maintain mathematical synchronization;
align transitions between visual elements at natural breaks in the narration including sentence endings and speaker changes in dialogue;
synchronize the narrated audio with the R visual media elements based on the mathematical timing relationship;
synchronize background music to align with scene boundaries where scenes comprise consecutive visual elements grouped by semantic content;
generate a documentary-style video output suitable for distribution via user-selected digital platforms;
wherein the visual elements comprise a mix of still images and video segments, each counted toward R total elements, and wherein the content modifiers are selected by the user and include online information links, theme/tone of the narrated video, preferred duration of video length, graphical-text quotation-frequency, the display time parameter, Opening Title sequence text-content, End Title sequence text-content, background music synchronized to scene durations, narration voice and narration type including multi-voice documentary formats.

2. (canceled)

3. (canceled)

4. The system of claim 1, wherein the AI text-to-audio generator determines the narration length of the generated AI-narrated audio file and divides the AI-narrated audio file length, using an image screen-time modifier, in time by a predefined screen time interval to determine the number of images, graphics or video sequences required for creating the AI-generated text-to video.

5. The system of claim 1, wherein the AI text-graphics generator determines the length of the generated AI-narrated audio file including all speaker segments and divides the audio file length in time by a user-chosen quotation-frequency factor selected from (a) the number of graphical text quotes to display per minute, or (b) display one text quote on every visual element or (c) on every pre-set number of visual elements in the video, to determine the timing and number of word-phrases/quotes needed to be overlayed in sync to the narrated video, while maintaining the mathematical relationship for visual element display.

6. The system of claim 1, wherein the visual media search engine uses LLM model with in-context learning to generate search keywords searching one or more multimedia databases to retrieve exactly R visual elements (images and/or video segments) that visually- and semantically-match and are relevant to the contextual information and meaning of the written content, with video segments limited to approximately S seconds matching the display time parameter.

7. The system of claim 1, wherein retrieving visual media includes automatically parsing and scraping online multimedia sources.

8. The system of claim 1, wherein the AI-based video generator automatically selects exactly R visual elements comprising images and/or video segments, and graphical elements, that convey a narrative aligned with the emotional and visual theme/tone selected by the user and relevant to the contextual information and meaning of the created draft text, ensuring each visual element displays for the display time parameter.

9. The system of claim 1, wherein the knowledge base is continually updated with images, graphics, and video segments retrieved by the LLM model from continually searching various multimedia databases along with their contextual meaning to build a knowledge base of visual content with searchable key-word descriptions, allowing the creation of videos for distribution, wherein video segments are stored as 3-5 second clips matching the S parameter range.

10. The system of claim 1, wherein the LLM model assigns a pre-determined value for each of the identified characteristics of the retrieved visual elements (images, graphics, or video segments) from the multimedia databases, wherein identified characteristics include title/name, textual description, location setting, main subjects of the scene, mood/atmosphere, an event type, duration of the clip, time of the day, camera angle/shot type, sound/music characteristics, color tone, lighting conditions, genre, language, special effects/visual enhancements, costumes/attire, character interaction, directional movement, pacing, weather conditions, historical context, theme, props, background elements, sound effects, speech patterns, cinematography style, narration presence, scene transition, editing style, symbolism, and cultural references, and other differentiating visual element characteristics to improve the accuracy of future searches for visual elements to be used in videos.

11. (canceled)

12. The system of claim 1, wherein the LLM model assigns a pre-determined value for each of the identified characteristics of the retrieved visual elements (images, graphics, or video segments) from the multimedia databases, wherein identified characteristics include title/name, textual description, location setting, main subjects of the scene, mood/atmosphere, an event type, duration of the clip, time of the day, camera angle/shot type, sound/music characteristics, colortone, lighting conditions, genre, language, special effects/visual enhancements, costumes/attire, character interaction, directional movement, pacing, weather conditions, historical context, theme, props, background elements, sound effects, speech patterns, cinematography style, narration presence, scene transition, editing style, symbolism, and cultural references, and other differentiating visual element characteristics to improve the accuracy of future searches for visual elements to be used in videos.

13. The system of claim 1, wherein the AI-based video generator divides the narration into 2 to 5 second segments in whole numbers of segments to synchronize AI-narrated audio with selected visual media.

14. The system of claim 1, wherein the AI-based video generator calculates visual segment duration based on optimal user engagement.

15. The system of claim 1, wherein the timing relationship ensures consistent pacing throughout the video.

16. The system of claim 12, wherein the LLM model assigns a pre-determined value for each of the identified characteristics and selects visual elements with highest collective values within each temporal segment of the narration.

17. The system of claim 1, wherein synchronizing the AI-generated visual overlays includes aligning text elements with corresponding narrative segments using the mathematical formula to ensure timing consistency, wherein the timing of overlays is coordinated with the R visual elements displaying for the display time parameter each, and wherein overlays identify speakers in multi-voice narratives.

18. (canceled)

19. A computer-implemented method for generating documentary-style video from narrative content with mathematically-determined visual element requirements, the method comprising:
receiving narrative content in any format including single narration, multi-speaker dialogue, interview transcripts, or hybrid documentary formats, and a user-selected display time parameter in seconds per visual element, wherein the display time parameter typically ranges from 2-5 seconds;
determining total narration duration N from the narrative content encompassing all speakers;
calculating a required number of visual elements R using a mathematical formula that divides the narration duration by the display time parameter;
parsing the narrative content to identify individual speakers and time-based transition points in multi-voice formats;
extracting semantic search terms from words, phrases, and sentences in the narrative content to capture both literal meaning and narrative context for each identified speaker;
querying a knowledge base of pre-existing documentary-style visual media including still images and video segments using the extracted semantic search terms;
scoring candidate visual elements based on semantic relevance to visualize the meaning of individual words and the overall story, with speaker-specific matching for dialogue segments;
selecting exactly R visual elements from the highest-scoring candidates to create a complete synchronized assembly, wherein visual elements comprise both still images and video segments;
arranging the selected R visual elements so that each element appears for the display time parameter duration, with video segments limited to approximately S seconds;
aligning transitions between visual elements at natural breaks detected in the narration, including sentence boundaries and speaker changes in dialogue;
synchronizing background music segments to scene boundaries where consecutive visual elements form semantic groupings;
overlaying speaker identification and attribution for multi-voice segments;
generating a documentary video output comprising the selected visual elements synchronized to the narrative audio with background music aligned to scene durations; and
providing the video as an automated assembly that maintains mathematical synchronization through the relationship between R visual elements and the display time parameter throughout the entire duration.

20. The method of claim 19, further comprising applying user-specified modifiers for content tone, duration, pacing, overlay frequency, screen-time allocation, title segments, background audio, and narration style.

21. The method of claim 19, wherein determining timing comprises applying the formula R=(N×60)/S to calculate the exact number of visual elements required and dividing narration duration by quotation-frequency modifier for text overlays, accounting for time-based transitions and speaker changes in dialogue segments.

22. The method of claim 19, further comprising generating synchronized text overlays based on AI-narrated audio file and a user-chosen quotation-frequency factor selected from the number of graphical text quotes to display per minute, display one text quote on every visual element, or display on every pre-set number of visual elements in the video, to determine the timing and number of word-phrases/quotes needed to be overlayed in sync to the narrated video.

23. The method of claim 19, wherein identifying visual content comprises generating semantic search queries using in-context learning with LLM to retrieve exactly R multimedia content items (images and/or video segments) that align visually and semantically with the written content.

24. The method of claim 19, further comprising updating a knowledge base with retrieved media tagged with semantic descriptors to improve future retrieval.

25. A computer-implemented method for analyzing the integrity of one or more contents in a website using an AI-based system interfaced with a Knowledge Base over a network, the method comprising:
receiving one or more user inputs, like a website address, a webpage address, web content addresses, or search-results of text, images, video segments, or graphics;
utilizing a large language Model with in-context learning using examples from data in the Knowledge Base to process contextual information from the received one or more inputs into creating a summarized draft text content;
comparing, using an AI evaluator that includes an LLM model, the summarized draft text content against a pre-determined list of truth descriptors and assigning an integrity score for the summarized text based on the comparison results and providing feedback on the integrity of the summarized text to the user based on the generated integrity score, wherein the integrity score and the feedback indicates the degree of accuracy and reliability of the summarized text;
converting, using an AI-based text-to-audio generator, the generated summarized draft text content into an AI-narrated audio file from the summarized text content with a user approved narration voice and narration type;
searching, using an image search engine that includes an LLM model, one or more multimedia databases for at least one of an image, a graphic, or a video segment that visually- and semantically-matches, is relevant to and in sync with the contextual information and meaning of the summarized draft text content;
combining, using an AI-based text-to-graphic generator, information from the large language model, to list a pre-determined number of most semantically-relevant word phrases or sentences per minute for user to choose, or for AI to automatically choose, to display as a colored, static-or-moving text-graphic in sync to and simultaneously with the spoken narrated audio words; and
synchronizing, using an AI-based video generator, the generated AI-narrated audio file with the at least one of an image, a graphic, or a video segment that is semantically matched to the contextual information to create and distribute an AI-generated video file by the user via email, SMS/text and/or social media messaging platforms.

26. The method of claim 25, wherein the pre-determined list of truth descriptors that identify information and categorizes said information into one or more categories selected from fake for entirely fabricated information, false for information contradicting verified records, misleading for twisted based on fact, unproven for lack of evidence to support/disregard the information, inaccurate for inaccuracies in data; context-required for lacking supporting contextual information; flip-flop for change in stance of public figure; unsubstantiated for being based on rumors; partially true for having mix of truth and friction; overgeneralization for broad information lacking specific evidence, speculative for being based on conjecture, and anachronistic for being based on evidence on a wrong time period.

27. The method of claim 25, wherein comparing using an AI evaluator includes scanning websites and summarizing information from said websites to identify key rumors, conspiracy stories, and lies by evaluating against one or more reliable sources, including governmental, academic, and verified media outlets, to create a list of blacklisted websites for storing in the Knowledge base with corresponding truth descriptors.

28. The method of claim 25, wherein generating AI summarized text includes information from the Knowledge Base that has been updated with pre-screened and graded using the predetermined list of Truth Descriptor for reliability, accuracy, and source reputation of the information, wherein the information with a low integrity score is excluded from the Knowledge Base.

29. The method of claim 27, wherein comparing further includes dynamically monitoring and updating the Blacklisted websites and Truth Descriptor Intensity scores for preventing any information from the Blacklisted websites for inclusion in the Knowledge Base, to ensure the Knowledge Base remains free of false or unreliable data and maintain credibility of AI-generated summaries and outputs.

30. The system of claim 1, wherein the mathematical formula comprises R=(N×60)/S, wherein:
R represents the number of visual elements (images and/or video segments) required for the video,
N represents the total narration duration in minutes including all speakers,
S represents the display time parameter in seconds per visual element, and
the formula ensures that R×S=N×60 for synchronized timing regardless of narrator count.

31. The system of claim 30, wherein the formula R=(N×60)/S provides mathematical certainty in determining the exact number of visual elements required before retrieval begins, transforming subjective video editing decisions into an objective calculation.

32. The system of claim 30, wherein for complex visual content including charts, maps, or detailed photographs, the system adjusts S locally while maintaining the overall R=(N×60)/S relationship by compensating with adjacent visual element durations.

33. The system of claim 30, wherein the formula can be equivalently expressed as R×S=N×60 demonstrating the mathematical relationship ensures perfect synchronization.

34. The system of claim 30, wherein selecting exactly R visual elements and displaying each for approximately S seconds ensures the mathematical relationship R×S=N×60 is maintained, providing synchronized timing between narration and visual progression.

35. The system of claim 1, wherein the 2-5 second range for the display time parameter is based on cognitive processing research indicating that viewers require 2-3 seconds minimum to comprehend a visual element while simultaneously processing narration.

36. The method of claim 19, wherein the mathematical formula comprises R=(N×60)/S, wherein N represents narration duration in minutes from all speakers and S represents the display time parameter in seconds.

37. The method of claim 19, wherein the mathematical formula comprises R=T/S, wherein T represents total narration duration in seconds from all speakers and S represents the display time parameter in seconds.

38. The method of claim 19, wherein the mathematical formula comprises R=(N×K)/S, wherein N represents narration duration, K represents a conversion factor, and S represents the display time parameter.

39. The method of claim 37, wherein the formula R=(N×60)/S enables pre-production planning by determining resource requirements before video assembly begins, eliminating iterative trial-and-error approaches.

40. The method of claim 37, further comprising displaying the mathematical relationship to users as “Number of Visual Elements Needed=Total Narration (seconds)/Average Scene Duration (seconds)” for intuitive understanding.

41. The system of claim 1, further comprising transition alignment means for optionally aligning visual element transitions at natural breaks in the narration, including pauses between sentences and speaker changes in dialogue.

42. The system of claim 1, wherein the visual media search engine further comprises semantic-emotional analysis means for selecting visual elements that create emotional stimulation and persuasive impact, comprising:
emotional tone extraction from narrative text to identify feelings, moods, and persuasive intent;
visual emotion mapping that correlates text emotions to visual characteristics including color temperature, composition dynamics, and subject expressions;
persuasion optimization scoring that ranks visual elements based on their ability to amplify the emotional message of the narration.

43. The system of claim 42, wherein the semantic-emotional analysis means evaluates narrative segments for:
primary emotions (joy, sadness, fear, anger, surprise, trust);
narrative emotional arc (building tension, climax, resolution);
persuasive elements (urgency, credibility, aspiration, concern); and
teaching moments requiring visual reinforcement for lesson retention.

44. The system of claim 42, wherein selecting exactly R visual elements comprises prioritizing elements that:
match the emotional valence of corresponding narrative segments;
progressively build emotional engagement throughout the video;
reinforce persuasive messaging through visual metaphors; and
enhance story comprehension through emotionally-appropriate imagery.

45. The system of claim 1, wherein semantic relevance scoring assigns hierarchical weights:
literal keyword matches receive base weight W;
contextual meaning matches receive weight 2W;
emotional resonance matches receive weight 3W;
persuasive impact matches receive weight 4W; wherein visual elements with highest combined weights are selected to maximize emotional engagement and message retention.

46. The method of claim 19, wherein scoring candidate visual elements based on semantic relevance comprises:
analyzing emotional connotations beyond literal word meanings;
identifying visual elements that trigger targeted emotional responses;
selecting elements that create emotional coherence between audio narration and visual presentation;
optimizing for viewer engagement through emotionally-compelling visual storytelling.

47. The system of claim 42, wherein for educational content, the semantic-emotional analysis means:
identifies key learning objectives requiring visual reinforcement;
selects visual elements that enhance memory formation through emotional association;
matches visual complexity to cognitive load requirements;
creates visual-emotional anchors for improved information retention.

48. The system of claim 42, wherein for storytelling content, the semantic-emotional analysis means:
maps story emotions to archetypal visual patterns;
selects visual elements that build narrative tension and release;
maintains emotional continuity across the exactly R visual elements;
amplifies story climax through peak emotional visual selection.

49. The system of claim 1, wherein the mathematical formula R=(N×60)/S operates synergistically with semantic-emotional selection by:
determining the exact quantity R of visual elements needed for perfect synchronization;
enabling semantic-emotional analysis to select the specific R elements for maximum impact;
ensuring each emotionally-selected element displays for optimal cognitive processing time S;
creating mathematically-precise emotional pacing throughout the video duration.

50. The system of claim 1, wherein the narration duration N serves as the master timing parameter that determines:
exactly R visual elements through the formula R=(N×60)/S;
total music duration of N×60 seconds;
number of musical bars as (N×60×BPM)/(60×beats per bar); wherein background music is selected based on the combined semantic meaning and mood derived from both the narrative content and the selected R visual elements, and synchronized to align with scene boundaries.

51. The system of claim 50, wherein for segments of consecutive visual elements forming scenes within the R total elements, the system:
calculates scene duration as (number of elements in scene)×S seconds;
determines musical bars needed per scene based on scene duration;
selects music matching the semantic mood of that narrative segment;
aligns musical transitions with scene boundaries occurring at S-second intervals.

52. The method of claim 19, wherein the narration duration drives a unified timing architecture where:
the formula R=(N×60)/S determines visual element quantity from narration;
semantic analysis of the narrative determines element selection;
music duration equals N×60 seconds derived from the same narration;
musical segments align with semantic scene groupings;
all timing relationships automatically recalculate when narration duration changes.

53. The system of claim 1, wherein for multi-speaker dialogue narratives, the system:
identifies speaker transitions through time-based analysis;
performs speaker-specific semantic matching to retrieve appropriate visual content;
overlays speaker identification synchronized with dialogue segments; and
maintains the R=(N×60)/S relationship across all speakers.

54. The system of claim 1, wherein the narrative content comprises a documentary script including:
narrator voice-over segments;
interview questions and responses;
dialogue between documentary subjects;
archival audio with multiple speakers; wherein the formula R=(N×60)/S applies uniformly regardless of speaker count or format.

55. The method of claim 19, wherein visual elements comprise:
still images including photographs, charts, maps, and infographics;
video segments of 3-5 seconds duration matching the S parameter range;
mixed assemblies combining both media types; wherein each element type counts equally toward the R total calculated by the formula.

56. The system of claim 1, wherein the background music synchronization comprises:
identifying semantic scene boundaries where consecutive visual elements share thematic content;
calculating scene duration as the sum of display times for elements within the scene;
selecting music segments with duration matching the calculated scene duration; and
aligning music phrase boundaries with visual element transitions at S-second intervals.

57. The system of claim 1, wherein the mathematical formula comprises R=T/S, wherein:
R represents the number of visual elements required,
T represents total narration duration in seconds encompassing all speakers,
S represents the display time parameter in seconds per visual element.

58. The system of claim 1, wherein the mathematical formula comprises R=(N×K)/S, wherein:
R represents the number of visual elements required,
N represents narration duration from all speakers,
K represents a time unit conversion factor,
S represents the display time parameter.

59. The method of claim 19, wherein synchronizing background music segments comprises:
grouping consecutive visual elements into semantic scenes based on content analysis;
determining scene duration from the count of elements multiplied by the display time parameter S;
matching musical segments to scene durations while maintaining the overall N×60 second music duration;
ensuring musical transitions coincide with scene boundaries for enhanced viewer experience.
